(19) United States
(12) Patent Application Publication
(10) Pub. No.: US 2003/0077448 A1
(43) Pub. Date: Apr. 24, 2003

(54) Ferromagnetic-metal-based powder, powder core using the same, and manufacturing method for ferromagnetic-metal-based powder

(75) Inventors: Masateru Ueta, Chiba (JP); Naomichi Nakamura, Chiba (JP); Satoshi Uenosono, Chiba (JP)

Correspondence Address: OLIFF & BERRIDGE, PLC, P.O. BOX 19928, ALEXANDRIA, VA, 22320, US

(73) Assignee: KAWASAKI STEEL CORPORATION, Kobe-shi (JP)

(21) Appl. No.: 10/101,735

(22) Filed: Mar. 21, 2002

(30) Foreign Application Priority Data
Mar. 27, 2001 (JP) 2001-090884
Jun. 7, 2001 (JP) 2001-172529
Nov. 29, 2001 (JP) 2001-364658
Feb. 6, 2002 (JP) 2002-030142
Mar. 11, 2002 (JP) 2002-065515

(51) Int. Cl. B22F 7/00; B32B 27/02; B05D 7/00; B32B 9/00

(52) U.S. Cl. 428/403; 428/404; 428/405; 427/216; 419/8

(57) ABSTRACT

An iron-based powder including a heat-resistant insulate coating and a powder core are suggested. A paint containing silicone resin and pigment is added to a raw material powder primarily containing a ferromagnetic metal, especially, iron, agitation and mixing are performed and, thereafter, a drying treatment is performed so as to form a coating containing silicone resin and pigment on the surface of the iron-based powder. The ratio of the silicone resin content to the pigment content in the coating is preferably 0.01 or more, but less than 4.0 on a mass basis. The pigment is preferably at least one selected from the group consisting of metal oxides, metal nitrides, metal carbides, minerals, and glass. The paint may be sprayed to the iron-based powder in a fluidized state. A coating containing at least one of Si compounds, Ti compounds, Zr compounds, P compounds, and Cr compounds may be formed as a lower layer of the aforementioned coating.

### BACKGROUND OF THE INVENTION

1. Field of Invention

The present invention relates to a ferromagnetic-metal-based powder, for example, an iron-based powder, and relates to a powder core using the ferromagnetic-metal-based powder. In particular, the present invention is suitable for a powder core used as choke coils, noise filters, and the like in power circuits, etc., and for an iron-based powder which is used as a material for the powder core.

2. Description of Related Art

In recent years, regarding household electrical appliances and electronic apparatuses, requirements for miniaturization of apparatuses and increases in power conversion efficiencies have increased. Consequently, switching power supplies have been widely adopted for power circuits. Accompanying the increased requirements, regarding the switching power supplies, further miniaturization and increases in efficiencies have been required. In addition, the capability of larger power output has been required.

In order to realize the increase in efficiency, miniaturization, and output of the switching power supply, it is very effective to increase the switching frequency and the output current to achieve a high current. Especially in recent years, such a trend has been remarkable. Most of all, the increase in frequency and switching power supplies, which can be operated in the range of 10 kHz to 100 kHz, are the mainstream as of now.

Accompanying the increase in switching frequency and increase in current, components using magnetic materials, which are used for the switching power supplies (for example, reactors, choke coils, and noise filters), have also been required to deliver performance in high frequency regions of 10 kHz or more and even under conditions in which high current is applied. Specific examples of performances required at this time include reduction of energy loss due to magnetic materials, that is, low core loss, and high saturation magnetic flux density so that magnetic saturation does not occur even when high current is passed.

Electrical steel plate cores, soft ferrite cores, powder cores, etc., have been used for reactors, choke coils, and noise filters of switching power supplies. Although the electrical steel plate core has advantages of high saturation magnetic flux density and relative inexpensiveness, there has been a problem in that eddy current in the steel plate increases rapidly with increase in operating frequency. Accompanying this, heat generation in the iron core and magnetic core loss (so-called core loss) increase rapidly. On the other hand, although the soft ferrite core has had low core loss, there has been a problem in that the saturation magnetic flux density has been low.

In contrast, the powder core is a core produced by pressing a powder mixture. In this process, a binder, for example, a resin, is appropriately added to a metal powder. After pressing, hardening treatment by heating, etc., so-called curing, may be performed in order to cure the added resin and the like. Examples of metal powders to be used include ferromagnetic metal powders, for example, an iron powder, an iron-based powder, e.g., Fe—Si powder, sendust powder, and Permalloy powder, or an amorphous iron-based alloy powder.

Since the powder core uses a metal powder as a raw material and a resin, having superior insulation property, as a binder, the core loss in high frequencies is lower than that of an iron core using a electrical steel plate. Furthermore, since the raw material is a metal powder, the saturation magnetic flux density becomes higher than that of the soft ferrite core.

Consequently, in recent years, the powder core has attracted great amounts of attention as a core material instead of the electrical steel plate and soft ferrite. However, in the switching frequency regions of 10 kHz to 100 kHz, there is a problem in that the core loss of the powder core is still large. Therefore, because the powder core becomes a new core material instead of the electrical steel plate and soft ferrite, reduction of the core loss of the powder core is indispensable.

The core loss of powder core is broadly divided into hysteresis loss and eddy-current loss. Hereto, various research experiments have been performed in order to reduce the eddy current loss. For example, Japanese Unexamined Patent Application Publication No. 58-147106 discloses a method in which the particle diameter of a metal powder is controlled, and Japanese Unexamined Patent Application Publication No. 62-71202, 62-29108, 2-153003, etc., disclose methods in which a metal powder and a material having an insulation property, for example, a resin, are mixed.

On the other hand, various research experiments have also been performed in order to reduce hysteresis loss. It has been pointed out that strain relief annealing of a compact has been effective for reduction of hysteresis loss (Horie et al. Journal of Magnetics Society of Japan, vol. 22, No.2, 45-51 (1998) and the like), and it has been known that an annealing at 650° C. or more has been especially effective. However, when annealing is performed in order to reduce hysteresis loss, there is a problem in that a resin, which is an insulation material, is decomposed and the insulation property is degraded by a large degree. Therefore, it has been said that compatibility between the reduction of eddy current loss and the reduction of hysteresis loss has been very low.

In order to make the reduction of eddy current loss and the reduction of hysteresis loss compatible, some methods have been suggested in which an insulation material having superior heat resistance and a metal powder are mixed. For example, in Japanese Unexamined Patent Application Publication No. 6-260319, a manufacturing method for high frequency powder core is described, in which a soft magnetic powder and a vitreous insulation agent containing P, Mg, B, and Fe as indispensable elements are mixed and dried to remove water, and subsequently, are solidified, pressed, and annealed. Regarding the powder core produced by the technique described in Japanese Unexamined Patent Application Publication No. 6-260319, it is said that strain is relieved by annealing at a temperature of 400° C. to 600° C. However, regarding an insulation-treated powder produced by this technique, the insulate coating is destroyed when it is pressed at a pressure of 588 MPa (6,000 kgf/cm²) or more. Consequently, there is a problem in that a mean, in which the saturation magnetic flux density is increased by increasing a pressing pressure and, therefore, by increasing compact density, cannot be used.

In Japanese Unexamined Patent Application Publication No. 61-222207, a manufacturing method for an iron core, in which a magnetic metal powder is contacted with silica sol or alumina sol, is described. An adhesion layer having an electrical insulation property is formed on the surface of a magnetic pure metal powder by drying and, thereafter, compression molding is performed so as to produce the iron core. According to the technique described in Japanese Unexamined Patent Application Publication No. 61-222207, if necessary, at least one powder selected from the group consisting of magnesium oxides, chromium oxides, titanium oxides, and aluminum oxides may be added to the silica sol or alumina sol and, thereafter, the magnetic metal powder may be contacted with them. According to the technique described in Japanese Unexamined Patent Application Publication No. 61-222207, these iron cores may be subjected to annealing at a temperature of 500° C. or less.

However, since a body produced by this method has a remarkably low strength, the powder core made by annealing the body also has a low strength. The low strength causes a problem in that winding around the annealed body cannot be performed.

Some manufacturing methods for powder core have been suggested, in which a polysilazane compound and an iron-based powder have been mixed. When the polysilazane compound is thermally decomposed, silica, which is an oxide of Si, is generated. For example, in Japanese Unexamined Patent Application Publication No.9-78206, a manufacturing method for a magnetic material is described, in which silicone oil is blended to a fine powder of Fe, the resulting mixture is pressed and heat-treated so as to disperse oxides of Si in the body and, thereafter, is sintered. In Japanese Unexamined Patent Application Publication No. 10-144512, a manufacturing method for a powder core is described, in which a metal powder made of a Fe, Si, Al-based alloy and perhydropolysilazane as a binder are used, subjected to compression molding and, thereafter, heat-treated. However, regarding these techniques, there is a problem in that insulation property after annealing is still remarkably low.

In Japanese Unexamined Patent Application Publication No. 2-97603, a manufacturing method for a powder core is disclosed, wherein an oblate iron powder, a powder containing silicon, and an inorganic compound powder having inertness toward silicon are mixed and heat-treated so as to produce a silicon-iron alloy powder in which silicon has been diffused into the iron powder, the resulting alloy powder is coated with water glass, etc., so as to form an insulate layer and, thereafter, press and heat treatment are performed. However, since the water glass used in the technique described in Japanese Unexamined Patent Application Publication No. 2-97603 as the material for the insulate layer contains ions of Na, which is an alkali metal element, there is a problem in that the insulation property is inadequate.

### SUMMARY OF THE INVENTION

The present invention was made in consideration of the aforementioned problems in the conventional techniques. Accordingly, it is an object of the present invention to suggest a ferromagnetic-metal-based powder (especially, an iron-based powder) in which insulation is not destroyed during annealing for reducing hysteresis loss, and which is suitable for a powder core having a heat-resistant insulate coating, and to suggest a powder core and a manufacturing method for the ferromagnetic-metal-based powder.

In order to achieve the aforementioned objects, the inventors of the present invention performed research on a means for improving the heat resistance of insulate coating without increase in eddy current loss while insulation was maintained even after annealing for the purpose of reducing hysteresis loss. As a result, it was found out that when a silicone resin and pigment are added in combination to a ferromagnetic raw metal powder, especially a raw material powder primarily containing iron, superior heat-resistant insulate coating is formed on the powder surface for the first time. It was also found that when materials such as metal oxides, metal nitrides, metal carbides, minerals, and glass are used as the pigment, a ferromagnetic-metal-based powder having a heat-resistant insulate coating, which has remarkably superior insulation property even after annealing, has superior body strength and annealed body strength. The inventors of the present invention found out that when a ferromagnetic raw metal powder (especially, a raw material powder primarily containing iron) was made to be a powder including a coating which contains at least one material selected from the group consisting of silicon compounds, titanium compounds, zirconium compounds, phosphorus compounds, and chromium compounds and which is formed beforehand on the surface of the powder, and the aforementioned heat-resistant insulate coating is formed on the coating, an iron-based powder further having superior insulation property after annealing could be produced.

The present invention has been achieved based on the aforementioned findings and further research.

According to an aspect of the present invention, a ferromagnetic-metal-based powder (especially, an iron-based powder) is provided, wherein the surface of a ferromagnetic metal powder (especially, a powder primarily containing iron) is coated with a coating containing silicone resin and pigment. In the present invention, the ferromagnetic-metal-based powder preferably includes a coating containing at least one material selected from the group consisting of silicon compounds, titanium compounds, zirconium compounds, phosphorus compounds, and chromium compounds as a substrate layer of the coating containing silicone resin and pigment. The ratio of the silicone resin content to the pigment content in the coating containing silicone resin and pigment is preferably 0.01 or more, but less than 4.0 on a mass basis. Preferably, the pigment is at least one selected from the group consisting of metal oxides, metal nitrides, metal carbides, minerals, and glass. According to this invention, the total adhesion amount of the silicone resin and pigment in the coating containing silicone resin and pigment is preferably 0.01% to 25% by mass relative to the total amount of the ferromagnetic-metal-based powder.

According to another aspect of the present invention, a powder core is made into a predetermined shape (targeted shape) by pressing any one of the aforementioned iron-based powders, or a powder core made by further annealing of the aforementioned powder core. The density of the powder core is preferably at least 95% or more of the true density. More preferably the powder core, is 98% or more of the true density.

According to another aspect of the present invention, a manufacturing method for a ferromagnetic-metal-based powder including the step of forming an insulate coating containing silicone resin and pigment on the surface of a ferromagnetic raw metal powder is provided. Preferably, the manufacturing method for a ferromagnetic-metal-based powder (especially, an iron-based powder) includes the step of spraying paint containing silicone resin and pigment on the ferromagnetic raw metal powder (especially, a raw material powder primarily containing iron) in a fluidized state so as to form an insulate coating on the surface of the raw material powder. Preferably, the manufacturing method for a ferromagnetic-metal-based powder (especially, an iron-based powder) of the present invention includes the steps of adding the paint containing silicone resin and pigment to the ferromagnetic raw metal powder (especially, a raw material powder primarily containing iron), agitating and mixing the resulting mixture, and performing a drying treatment so as to form an insulate coating on the surface of the raw material powder. In the present invention, preferably, a coating containing at least one material selected from the group consisting of silicon compounds, titanium compounds, zirconium compounds, phosphorus compounds, and chromium compounds is formed beforehand on the surface of the raw material powder. Preferably, the total adhesion amount of the silicone resin and pigment in the coating containing silicone resin and pigment is 0.01% to 25% by mass relative to the total amount of the ferromagnetic-metal-based powder, and the ratio of the silicone resin content to the pigment content in the paint is 0.01 or more, but less than 4.0 on a mass basis.

According to the present invention, an iron-based powder including a heat-resistant insulate coating in which insulation is not destroyed during annealing for reducing hysteresis loss, and a powder core having superior insulation property can be produced. Therefore, the present invention exhibits remarkable industrial effects.

### BRIEF DESCRIPTION OF THE DRAWINGS

FIG. 1 is a diagram showing the relationship between the pressing pressure and the powder core density.

FIG. 2 is a diagram showing the relationship between the powder core density and the magnetic flux density.

### DESCRIPTION OF THE PREFERRED EMBODIMENTS

A ferromagnetic-metal-based powder (especially, an iron-based powder) according to the present invention is a powder including an insulate coating having superior heat resistance in which the surface of a ferromagnetic metal powder (especially, a powder primarily containing iron) is coated with a coating containing silicone resin and pigment. The coating containing silicone resin and pigment can cover the metal particle directly without any intermediate layer. The coating can be used as the only coating layer or can cover with other layers over or under there of.

In the following description, an iron-based powder using a raw material powder composed of a powder primarily containing iron is described as an example, unless otherwise specified. The iron-based powder can be available or can be inexpensively produced and, therefore, the iron-based powder is predicted to become a primary application of the present invention. However, the present invention can be applied to any ferromagnetic-metal-based powder to exhibit advantageous effects.

A preferable manufacturing method for the iron-based powder according to the present invention will be described.

The paint containing silicone resin and pigment is added to the raw material powder, and agitation and mixing are performed, or, preferably the aforementioned paint containing silicone resin and pigment is sprayed on the raw material powder primarily containing iron in a fluidized state and, thereafter, a drying treatment is performed so as to remove a solvent. Consequently, a coating containing silicone resin and pigment is formed on the surface of the raw material powder.

Herein, “agitation and mixing” refers to mixing substantially accompanied by agitation performed in order to achieve homogeneous mixing. Therefore, the case where materials are mixed and, thereafter, agitation is applied is also included in “agitating and mixing” because homogeneous mixing is achieved by agitation.

Furthermore, “fluidized state” refers to a state in which fluidity of a powder (or mixture of gas and powder) is improved, or fluidization is further effected by introducing a gas into the powder and, in addition to this, by agitating with rotating plates, rotating blades, etc., if necessary. The fluidized state can be realized by the use of an apparatus called a fluidized tank.

When the paint containing silicone resin and pigment is added to the raw material powder, and agitation and mixing are performed, both may be agitated and mixed at a time, or the raw material powder and a part of the paint may be agitated and mixed, the remainder of the paint may be added during mixing, and further agitation and mixing may be performed. A part of the paint may be agitated, mixed, and dried and, subsequently, the same paint or paint having a changed composition may be agitated and mixed. This operation may be repeated a plurality of times. Thus, a targeted powder can be produced.

Atritor, Henschel mixer, ball mill, fluidized granulator, rolling fluidized granulator, etc., can be used for agitation and mixing. Most of all, the fluidized granulator and rolling fluidized granulator can produce powder mixtures having reduced variations in particle diameter because agitation is performed with a fluidized tank and, therefore, coagulation among powder particles is hindered.

The paint may be added to the raw material powder by spraying with a spray nozzle. By spraying the paint, the silicone resin and the pigment are added uniformly and, therefore, the coating which contains the silicone resin, the pigment and is formed on the surface of the raw material powder becomes uniform. Furthermore, when the paint is added to the raw material powder in a fluidized state by spraying with a spray, etc., an effect of spraying and an effect of using a fluidized tank are synergized and, therefore, further uniform coating is formed on the surface of the raw material powder. Regarding spray of the paint, when a solvent is promptly and appropriately dried, agglomeration of particles may occur based on a liquid bridge force due to the remaining liquid, and the like. Preferably, the amount of spray is controlled in order to avoid this phenonenom.

A heat treatment may be performed during mixing (or agitation and mixing) or after mixing (or agitation and mixing) in order to accelerate drying of the solvent, to cure the silicone resin, and the like.

The paint used in the present invention and blended into the raw material powder is paint in which the silicone resin and the pigment are dispersed in a solvent. In the present invention, silicone resin refers to polyorganosiloxane including mono-functional (M unit), di-functional (D unit), tri-functional (T unit), or tetra-functional (Q unit) siloxane units in a molecule.

The silicone resin has a crosslinking density higher than that of silicone oil, silicone rubber, etc., When a silicone resin is cured it becomes hard. Although the silicone resin is broadly divided into straight silicone resin in which the only component is silicone alone and silicone modified organic resin, which is a copolymer of a silicone component and an organic resin, any one of them can be used as the silicone resin in the present invention with noadverse affects.

The straight silicone resin is broadly divided into MQ resin and DT resin. However, any one of them may be used in the present invention.

Examples of silicone modified organic resins include, for example, alkyd modified type, epoxy modified type, polyester modified type, acrylic modified type, and phenol modified type. However, any one of them may be used in the present invention. Although modified type resins include those available as intermediates, they can also be used in the present invention.

The silicone resin is cured by heating. However, the resins which cure even in room temperature may be called, a room temperature curing type, and this may be differentiated from the type cured by intentional heating (thermosetting type). The curing mechanism of the thermosetting type silicone resin is broadly divided based on dehydration and condensation reaction, addition reaction, peroxide reaction, etc. On the other hand, the curing mechanism of the room temperature curing type silicone resin includes the resins based on deoxime reaction, dealcohol reaction, etc.

In addition, there are resins which are cured by a curing reaction similar to that of an alkyd resin, polyester resin, or epoxy resin. Those may be classified into the room temperature curing type, and may be classified into the thermosetting type. Furthermore, photo-curing may occur.

In the present invention, any silicone resin can be used suitably regardless of its curing type. However, a room temperature curing treatment and thermosetting treatment are especially suitable for the method for forming a coating.

Examples of brands of silicone resin suitable for the present invention include, for example, SH805, SH806A, and SH840 (methyl-phenyl silicone: a sort of DT resin-based straight silicone resin/thermosetting type), SH997, SR620, SR2306, SR2309, SR2310, SR2316, and DC12577 (phenyl-based resin: a sort of DT resin-based straight silicone resin/room temperature curing type, but adhesion between a coating and a substrate is improved by thermosetting), SR2400 (methyl-based resin: a sort of DT resin-based straight silicone resin/thermosetting type), SR2406, SR2410, SR2416, SR2420, and SR2402 (methyl-based resin/dealcohol room temperature curing type), SR2405 and SR2411 (methyl-based resin/deoxime room temperature curing type), SR2404 (methyl-based resin), SR2107 (silicone alkyd modified resin/curing is based on a curing reaction similar to that of the alkyd resin), SR2115 and SR2145 (silicone epoxy modified resin/curing is based on a curing reaction similar to that of epoxy resin), SH6018 (intermediate for modifying alkyd-polyester-epoxy resin containing silanol groups/curing is based on a curing reaction similar to that of each of alkyd, polyester and epoxy resins), DC2230 (intermediate for modifying alkyd-polyester resin containing silanol groups/curing is based on a curing reaction similar to that of each of alkyd and polyester resins), DC3037 (intermediate for modifying polyester resin containing methoxy groups/curing is based on a curing reaction similar to that of polyester resin), and QP8-5314 (intermediate for modifying acrylic emulsion resin containing methoxy groups) manufactured by Dow Corning Toray Silicone Co., Ltd., and include as similar products, for example, KR251, KR255, KR114A, KR112, KR2610B, KR2621-1, KR230B, KR220, KR285, KR295, KR2019, KR2706, KR165, KR166, KR169, KR2038, KR221, KR155, KR240, KR01-10, KR120, KR105, KR271, KR282, KR311, KR211, KR212, KR216, KR213, KR217, KR9218, SA-4, KR206, ES1001N, ES1002T, ES 1004, KR9706, KR5203, and KR5221 manufactured by SHIN-ETSU CHEMICAL CO., LTD. As a matter of course, silicone resins of other than the aforementioned brands may be used in the present invention with no problem.

A fine particle silicone resin which is dispersed in a solvent and becomes a colloidal state may be used. Examples of brands of it are R-920, R-925, manufactured by Dow Coring Toray Silicone. As a mater of course a fine particle resins of other than aforementioned brands may be used in the present invention with no problem.

Furthermore, silicone resins made by modifying these materials or raw materials thereof may be used. Silicone resins in which at least two kinds of silicone resins having different sorts, molecular weights, and functional groups are combined at a proper ratio may be used. The pigment used together with the silicone resin is not specifically limited as long as it has a high insulation property and heat resistance. However, the pigment is preferably at least one selected from the group consisting of metal oxides, metal nitrides, metal carbides, minerals, and glass. In particular, the metal oxides, metal nitrides, and metal carbides generally have a combination of high insulation property and heat resistance regardless of sorts.

Every metal oxides, metal nitrides and metal carbides have good insulation property and heat resistance, and thus, they are preferable for pigment.

Examples of preferable metal oxides include oxide powders of, for example, Li, Si, Al, Ti, Th, Zn, Zr, Be, Cu, Mg, K, Ca, Sn, Sb, Mn, Cr, Fe, Ni, and Co. The metal oxide to be added can be chosen from these materials in consideration of insulation property and cost. An oxide powder produced by oxidizing an alloy of at least two metals chosen from these materials may be used.

Examples of preferable metal carbides include, for example, SiC.

Examples of preferable metal nitrides include, for example, AlN, Si₃N₄, TiN, and BN.

Examples of preferable minerals having a high insulation property and heat resistance include, for example, mullite, magnesium silicate, bentonite, kaolinite, smectite, talc, natural mica, and artificial mica.

Examples of preferable glass include, for example, quartz glass, phosphoric acid-based glass, alumina-silica glass, boric acid-phosphoric acid-containing glass, and glass for enamel. Those containing large amounts of materials to be ionized, such as water glass (alkali glass), are not preferable because insulation property is inadequate and conductivity is increased by heat treatment. However, any other glasses may be used.

Among the aforementioned materials, especially preferable materials used as the pigment are magnesium silicate, bentonite, natural mica, artificial mica, titania (titanium oxide), alumina (aluminum oxide), copper oxide, iron oxide, and chromium oxide. Preferably, the pigment used in the present invention contains at least one chosen from these materials. A colloidal oxide, for example, colloidal silicon dioxide, colloidal alumina, may be used.

Examples of magnesium silicate include, for example, talc and forsterite. Examples of bentonite include, for example, Na-montmorillonite, Ca-Mg-montmorillonite, and organic bentonite produced by compounding montmorillonite or hectorite with an organic material. Examples of titania include, for example, anatase type titania and rutile type titania. Examples of alumina include, for example, corundum type alumina.

The pigment used in the present invention is preferably a powder made of the aforementioned material as a raw material. Examples of probable methods for producing a powder pigment include, for example, a pulverization method in which a raw material having a large particle diameter is pulverized, a sol-gel method or atomization method in which a powder is directly generated from a raw material using a chemical reaction, etc., and a method in which a powder is produced by a gas phase reaction. Any one of these methods may be used. Furthermore, a powder produced by a method other than the aforementioned methods may be used.

Preferably, the powder pigment suitably used for the present invention is a powder having an average particle diameter of 40 μm or less in order that surface asperities of the coating produced are reduced so as to make the film thickness, etc., uniform, and degradation of heat resistance is prevented. Herein, the average particle diameter refers to a 50% separation diameter D₅₀. The D₅₀ indicates a particle diameter at which a volume fraction (partition efficiency) becomes 50% in particle size distribution on a volume basis (hereafter referred to as Tromp curve) determined with a laser diffraction particle size analyzer, etc.

In the present invention, the aforementioned silicone resin and pigment are added to a solvent and mixing is performed so as to produce paint. Preferably, the compounding ratio of the silicone resin to the pigment in the paint is controlled in order that the ratio of the silicone resin content to the pigment content in the coating formed on the surface of the iron-based powder, R=(silicone resin content (% by mass))/ (pigment content (% by mass)) falls within the range of 0.01 or more, but less than 4.0 on a mass basis.

The solvent is not specifically limited as long as the silicone resin is dissolved or dispersed. The solvent is preferably, for example, an alcohol-based solvent typified by ethanol and methanol, ketone-based solvent typified by acetone and methyl ethyl ketone, aromatic-based solvent typified by benzene, toluene, xylene, phenol, and benzoic acid, and petroleum-based solvent, such as ligroin and kerosene. Among these, the aromatic-based solvent is especially preferable because the silicone resin is likely to be dissolved. Furthermore, water may be used if the silicone resin can be dissolved or can be dispersed. The concentration of the paint used in the present invention may be determined in consideration of easiness of working (attainment of quantitative addition amount, stability of spraying of the spray, etc.), time required for drying, etc.

Additives may be added to the paint suitably used for the present invention in order to control various characteristics of the paint, for example, viscosity, thixotropic property, leveling property, dispersibility of the pigment in the paint, time required until the paint becomes not adhesive to fingers which touch the coated surface (tack time), and strength and hue of the coating. The additives for the paint are preferably metal soaps, such as stearic acid metal salts, surfactants, such as perfluoroalkyl, and the like to control curing of the silicone resin.

Regarding the paint containing silicone resin and pigment, the pigment may sediment due to gravity and, therefore, may precipitate on the bottom of container. When the pigment is precipitated, the mass ratio of the pigment to the silicone resin may locally go out of the preferable range in the paint. Therefore, preferably, a sedimentation inhibitor is added to the paint in order to prevent precipitation of the pigment.

Examples of the aforementioned sedimentation inhibitors include, for example, the following materials; macromolecules, for example, starch and poly (vinyl alcohol), fine powders composed of resin, for example, polypropylene, or oxides, for example, silica and alumina, fine particles having a plate or layer structure typified by boron nitride, graphite, molybdenum disulfide, mica, talc, ferrite (iron oxide), vermiculite, kaolin, etc.

Among these, ceramic and clay minerals, for example, silica, alumina, boron nitride, mica, talc, ferrite, vermiculite, kaolin, etc., are preferable because they are superior in not only prevention of sedimentation, but also heat resistance and insulation property and, therefore, they can serve as the pigment of the paint used in the present invention as well.

Most of all, mica and talc are preferable because they have a plate structure and, therefore, exhibit high effect of preventing sedimentation. The addition amount of the sedimentation inhibitor required for achieving the effect of preventing sedimentation is different depending on the materials.

For example, in the case where mica or talc is used, the ratio thereof on a mass basis relative to the total pigment is specified to be preferably between 10% to 100% by mass, and more preferably, to be between 30% to 100% by mass.

When the paint containing pigment is used, in order to further reduce sedimentation, preferably, the paint is used after adequate agitation with a homogenizer, etc., or while being agitated. In the present invention, the paint in which the aforementioned silicone resin and pigment are blended into the solvent is directly dropped or is sprayed using a spray, etc., on the raw material powder primarily containing iron and, therefore, the paint is mixed with the raw material powder. Subsequently, a drying treatment is performed so as to form a coating containing the silicone resin and pigment on the surface of the raw material powder.

Preferably, the blending or spraying amount of the paint relative to the raw material powder is controlled so that the adhesion amount of the coating adhered and formed on the surface of the raw material powder becomes 0.01% to 25% on a percentage by mass basis relative to the total amount of the iron-based powder including the coating. That is, from the viewpoint of ensuring high insulation property after annealing, the adhesion amount of the coating is preferably specified to be 0.01% by mass or more. In order to maintain excellent magnetic flux density and magnetic permeability of the compact and to ensure a high body strength, the adhesion amount of the coating is preferably specified to be 25% by mass or less.

Preferably, the drying treatment in the present invention is specified to be a treatment of standing for 8 hours or more at room temperature or a treatment of heating at 50° C. to 300° C. for 0.1 to 24 hours from the viewpoint of adequate drying of the solvent. When drying of the solvent is inadequate, the powder may become sticky and handling of the powder may become very hard. Furthermore, the coating strength may be reduced due to the solvent remaining in the coating and, therefore, desired heat resistance may not be achieved.

In the present invention, preferably, the coating formed on the surface of the raw material powder contains the silicone resin and pigment in order that the ratio of the silicone resin content to the pigment content in the coating, R=(silicone resin content (% by mass))/ (pigment content (% by mass)) falls within the range of 0.01 or more, but less than 4.0 on a mass basis. In particular, this ratio is preferably specified to be 0.01 or more, but less than 2.0, and more preferably, be 0.01 or more, but less than 1.5. The lower limit value is preferably 0.2 or more, and most preferably, is more than 0.25.

The R value is specified to be 0.01 or more, and preferably, be 0.2 or more. That is, the silicone resin is preferably contained at a predetermined rate or more relative to the pigment, in order that the performance as the binder for adhering the pigment on the iron powder is adequately exhibited, and that degradation of the insulation property of the compact due to peeling of the coating during handling and pressing of the powder is prevented.

The R value is preferably specified to be 4.0 or less, that is, the ratio of the silicone resin relative to the pigment is preferably specified to be a predetermined value or less in order to avoid breakage of the coating due to reduction of fracture strength (because the silicone resin is brittle compared to the pigment) and volume change during annealing (because the silicone resin changes to silica), and to avoid reduction of insulation property of the compact due to the breakage of the coating.

Accordingly, in the present invention, the R is preferably less than 4.0, especially, is less than 2.0, and more preferably, is less than 1.5.

In order to control R=(silicone resin content (% by mass))/(pigment content (% by mass)) in the coating to be within the range of 0.01 or more, but less than 4.0, preferably, the compound ratio of the silicone resin to the pigment in the paint to be blended into or sprayed on the raw material powder is controlled.

The paint containing silicone resin and pigment is blended (agitation and mixing) into or sprayed on the raw material powder, and subsequently, drying is performed so as to remove the solvent. Therefore, an iron-based powder, in which a coating composed of silicone resin and pigment is formed on the surface, can be produced. Furthermore, a coating of the same paint or a coating of paint having a different R value or pigment composition, or having a different R value and pigment composition, may be formed over the iron-based powder produced as described above so as to produce an iron-based powder. A plurality of coatings may be overlaid so as to produce an iron-based powder.

In the present invention, a powder, in which a coating containing at least one material selected from the group consisting of silicon compounds, titanium compounds, zirconium compounds, phosphorus compounds, and chromium compounds is preferably formed beforehand on the surface thereof, is used as the raw material powder. By the method in which the coating containing at least one material selected from the group consisting of silicon compounds, titanium compounds, zirconium compounds, phosphorus compounds, and chromium compounds is formed beforehand on the surface of the raw material powder, the paint containing the aforementioned silicone resin and pigment is blended (agitation and mixing) into or sprayed on the resulting raw material powder and, subsequently, drying is performed so as to remove the solvent, an iron-based powder can be produced, in which a multilayer coating composed of a lower layer coating containing at least one material selected from the group consisting of silicon compounds, titanium compounds, zirconium compounds, phosphorus compounds, and chromium compounds, and an upper layer coating containing the silicone resin and pigment.

By including the aforementioned coating as the lower layer coating, the insulation property of the iron-based powder after annealing is further improved compared to that in the case where only the coating containing the silicone resin and pigment is included.

Next, a method for forming the coating containing at least one material selected from the group consisting of silicon compounds, titanium compounds, zirconium compounds, phosphorus compounds, and chromium compounds on the surface of the raw material powder (hereafter may be referred to as raw material powder) will be described.

The methods for forming the coating containing at least one aforementioned material on the surface of the raw material powder is now described. One method includes the step of adding the aforementioned materials to the raw material powder and, thereafter, performing agitating and mixing and finally drying. Another method includes the step of fluidizing or agitating the raw material powder, then spraying a material containg the aforementioned materials or a solution produced by diluting a material containing the aforementioned materials with a colvent on the raw material powder in a fluidized or agitated state, finally drying. Still another method includes the steps of immersing the raw material powder in the resulting solution for a predetermined time, finally drying the raw material powder. Although not limited to these methods in the present invention.

The method for forming a coating containing at least two sorts of compounds on the surface of the raw material powderis now described. The method includes the steps of mixing atleast two compounds beforehand, and the resulting mixture is added and treated, a method in which at least two sorts of compounds are prepared separately, and those are added at the same time and treated, a method in which materials containing a compound are added in sequence and treated, or the like is conceivable, although not limited to these methods in the present invention. Regarding the method in which materials containing a compound are added m sequence and treated, treatment ways may be different depending on the materials.

Furthermore, at least one compound for forming the lower layer coating may be added to the raw material powder by so-called integral blend in which the compound is added into the paint containing silicone resin and pigment. When a treatment for forming the lower layer coating is performed and, subsequently, a treatment for forming the upper layer coating is performed, further complete lower layer coating can be produced and insulation property after annealing is improved. In these treatments, the amount of the material containing the aforementioned materials (compounds), concentration of the solution, adding method, mixing method, etc., can be appropriately determined in accordance with the materials to be used and treating methods. Preferably, the content of silicon compound in the coating is specified to be 0.01% to 4% by mass relative to the total iron-based powder including the coating. The content of titanium compound in the coating is preferably specified to be 0.01% to 4% by mass relative to the total iron-based powder including the coating. The content of zirconium compound in the coating is preferably specified to be 0.01% to 4% by mass relative to the total iron-based powder including the coating. The content of phosphorus compound in the coating is preferably specified to be 0.01% to 4% by mass relative to the total iron-based powder including the coating. The content of chromium compound in the coating is preferably specified to be 0.01% to 4% by mass relative to the total iron-based powder including the coating.

In order to form the coating containing the silicon compound on the surface of the raw material powder, silane compounds, for example, alkoxysilane and acyloxysilane, silanizing agents, for example, organohalosilane and derivatives thereof, silicon peroxides, silicate compounds, etc., are used preferably as materials containing silicon compounds, although not limited to the silane compounds, silanizing agents, silicon peroxides, and silicate compounds in the present invention.

Examples of silane compounds include, for example, chlorosilane compounds, e.g., methyltrichlorosilane, methyldichlorosilane, dimethyldichlorosilane, trimethylchlorosilane, phenyltrichlorosilane, diphenyldichlorosilane, and trifluoropropyltrichlorosilane, heptadecafluorodecyltrichlorosilane, alkoxysilane compounds, e.g., tetramethoxysilane, methyltrimethoxysilane, dimethyldimethoxysilane, phenyltrimethoxysilane, diphenyldimethoxysilane, tetraethoxysilane, methyltriethoxysilane, dimethyldiethoxysilane, phenyltriethoxysilane, diphenyldiethoxysilane, hexyltrimethoxysilane, hexyltriethoxysilane, decyltrimethoxysilane, decyltriethoxysilane, trifluoropropyltrimethoxysilane, and heptadecatrifluorodecyltrimethoxysilane, silane coupling agents, e.g., vinyltriethoxysilane, vinyltris(-methoxyethoxysilane), vinyltriacetoxysilane, γ-methacryloxypropyltrimethoxysilane, γ-aminopropyltriethoxysilane, γ-(aminoethyl)aminopropyltriethoxysilane, γ-glycidoxypropyltrimethoxysilane, γ-mercaptopropyltrimethoxysilane, β-(3,4-epoxycyclohexyl)ethyltrimethoxysilane, and γ-chloropropyltrimethoxysilane, or silazanes, e.g., hexamethyldisilazane.

In the present invention, any one of the aforementioned materials is used with no problem. At least two of the aforementioned materials may be mixed and used. Furthermore, silane compounds other than those described above may be used. The silane compounds may be used without any further treatment, or may be used after being diluted with solvents.

Examples of silicon peroxides include, for example, materials typified by the molecular formula R₄₋ₙSi(OOR′)ₙ, e.g., vinyltris(t-butylperoxy)silane, although not limited to this. Herein, R represents an organic group, and n represents an integer of 1 to 4.

Examples of silicate compounds include, for example, alkyl silicates, e.g., ethyl silicate (tetraethoxysilane), methyl silicate, N-propyl silicate, and N-butyl silicate. These may be used after being hydrolyzed. Furthermore, for the purpose of controlling the coating properties, those made by the polymerization of alkyl silicate with n=on the order of 2 to 10 (this is also referred to as alkyl silicate), for example, Ethyl silicate 40(R) manufactured by COLCOAT CO., LTD.; chemical formula C₂H₅O—(SiO(OC₂H₅)₂)ₙ—C₂H₅ (wherein n=on the order of 5), may be used. Silicate compounds other than those described above may be used. The silicate compounds may be used without any further treatment, or may be used after being diluted with solvents.

In order to form the coating containing the titanium compound on the surface of the raw material powder, titanium coupling agents are preferably used as materials containing titanium compounds, although not limited to the titanium coupling agents in the present invention.

Examples of titanium coupling agents include, for example, titanium esters, e.g., tetraisopropyl titanate, tetraisopropyl titanate polymer, tetrabutyl titanate, tetrabutyl titanate polymer, tetrastearyl titanate, and 2-ethylhexyl titanate, titanium acylates, e.g., isopropoxytitanium stearate, titanium chelates, e.g., titanium acetylacetonate and titanium lactate. In the present invention, any one of the aforementioned materials is used with no problem. At least two of the aforementioned materials may be mixed and used. Coupling agents other than the aforementioned titanium coupling agents may be used. The titanium coupling agents may be used without any further treatment, or may be used after being diluted with solvents.

In order to form the coating containing the zirconium compound on the surface of the raw material powder, zirconium coupling agents are used preferably as materials containing zirconium compounds. Examples of zirconium coupling agents include, for example, zirconium alkoxide, although not limited to this.

In order to form the coating containing the chromium compound on the surface of the raw material powder, a chromium complex salt, in which organic anions are bonded, is used preferably as a material containing a chromium compound, although not limited to this.

In order to form the coating containing the phosphorus compound on the surface of the raw material powder, a solution in which phosphoric acid is diluted with a solvent, for example, water and organic solvents, a solution in which phosphate is dissolved into water, organic solvents, or a mixed solvent thereof, or phosphoric acid ester or phosphoric acid ester solution, etc., is used preferably as a material containing a phosphorus compound, although not limited to this. When phosphoric acid diluted with a solvent is used, the degree of reaction becomes likely to be controlled, the addition amount of phosphoric acid is reduced, and excessive generation of phosphorus compounds can be inhibited. Examples of at least two sorts of compounds include, for example, some kinds of phosphate compounds, although not limited to this. In order to form the coating containing the phosphate compounds on the surface of the raw material powder, a solution in which phosphate and chromate, preferably and surfactants, such as oxyethylen-oxypropylene block polymer, and boric acid are dissolved into water is used preferably as a material containing a phosphate compounds, although not limited to this. The content of compound including two or more sorts of aforementioned compounds in the coating is preferably specified to be 0.01% to 4% by mass relative to the total iron-based powder including the coating.

The sort of the raw material powder primarily containing iron used in the present invention is not specifically limited as long as it is a powder which exhibits ferromagnetism and has a high saturation magnetic flux density. In general, iron, steel, and iron alloys exhibit ferromagnetism and have high saturation magnetic flux densities.

Examples of the raw material powder primarily containing iron suitably used for the present invention include those descried below (composition is shown on a % by mass basis); iron powder (Fe content is 90% or more, and the remainder is impurities, for example, about 0.2% or less of carbon): especially, so-called pure iron powder containing 98% or more of Fe is preferable,

Fe—Si alloy powder: especially preferably, Si content is on the order of 0 to 6.5%, and the remainder is impurities as typified by, for example, Fe-3%Si alloy powder, Fe-4%Si alloy powder, and Fe-6.5%Si alloy powder,

Fe—Al alloy powder (preferably, Al content is on the order of 10 to 20%, and the remainder is iron and impurities),

Fe—Ni alloy powder (preferably, Ni content is on the order of 20% to 50%, and the remainder is iron and impurities), sendust powder (preferably, Al content is on the order of 4% to 6%, Si content is on the order of 9% to 11%, and the remainder is iron and impurities),

amorphous iron-based alloy, and

Thermoperm (Fe-30%Ni: the remainder is preferably impurities).

The aforementioned powders primarily contain iron, and iron content is 50% or more, and preferably, is 70% or more, although not limited to these, any metal powder which exhibits ferromagnetism can be used in the present invention. For example, the present invention can be applied to a Permalloy primarily containing iron and nickel, and the like. Examples of suitable Permalloys include, for example, 45Permalloy (Fe-45%Ni), 68Permalloy (Fe-68%Ni), 78Permalloy (Fe-78.5%Ni), 4-79Permalloy (Fe-4%Mo-79%Ni), and 2-81 Permalloy (Fe-2%Mo-81%Ni), wherein the remainder is impurities, although not limited to these. In the cases where these Permalloys are used, ferromagnetic-metal-based powders are produced instead of iron-based powders.

In the present invention, at least one powder selected from these ferromagnetic metal powders, especially from the powders primarily containing iron is used preferably as a raw material powder. Even when small amounts of (preferably 10% or less) additives and impurities, which are not ferromagnetic materials, are present in the raw material powder, there is no problem as long as the powder exhibits ferromagnetism.

The shape of the powder is not specifically limited. For example, oblate iron-based powder processed to be oblate by some manufacturing methods or mechanical processing (for example, crushing) may be used as the aforementioned raw material powder.

Among the raw material powders, pure iron powders typified by atomized iron powders, electrolytic iron powders, etc., have not only superior magnetic characteristics, such as saturation magnetic flux density and permeability, but also superior compressibility and are inexpensive. Consequently, the pure iron powders are suitable for the raw material powder primarily containing iron in the present invention. Examples of pure iron powders include, for example, KIP(R)-MG270H, KIP(R)-304A, and KIP(R)-304AS manufactured by Kawasaki Steel Corporation.

The particle diameter of the raw material powder used in the present invention is not specifically limited, although it is desirable that the particle diameter is appropriately determined in accordance with uses and required properties of the powder core. For example, when particles having a large particle diameter are taken out by classification and are used, compressibility is improved. Furthermore, magnetic gaps generated among particles are reduced by a large degree. As a result, a powder core having a high permeability, high magnetic flux density, and remarkably reduced hysteresis loss due to reduction of magnetic gaps can be produced. Such a powder core is suitable for the use in which usable frequencies are on the order of 1 kHz or less, and a high magnetic flux density is required. In this case, the particle diameter is preferably 75 μm or more, and more preferably, is 100 μm or more.

It is well known that when the particle diameter of the iron-based powder is reduced, eddy current loss is reduced because the amount of eddy current passing through the particle is reduced. Consequently, when particles having small particle diameters are taken out of the raw material powder in advance by classification and are used, reduction of core loss due to eddy current loss can be realized. This is very effective for reduction of iron loss in high frequency regions in which the eddy current loss makes up a large proportion of the total core loss compared to that in low frequency regions (for example, 1 kHz or less). The powder core produced using such an iron-based powder is suitable for the use where usable frequencies are on the order of 10 kHz to 500 kHz, and reduced loss is required. In this case, the particle diameter is preferably 75 μm or less. It is known that a powder having a small particle diameter exhibits a somewhat reduced compact density and magnetic flux density compared to those of a powder having a large particle diameter when pressed under the same conditions. However, the compact density can be improved by, for example, increasing the pressing pressure. By taking advantage of this, even when the powder having a small particle diameter is used, a powder core exhibiting a high magnetic flux density and at the same time exhibiting a reduced core loss can be produced.

The ferromagnetic raw metal powder, especially the raw material powder, may be used after the elements contained therein are adjusted within the range in which compressibility and magnetic characteristics of the powder core are not adversely affected.

The ferromagnetic-metal-based powder produced by the aforementioned method, especially the iron-based powder sometimes contains small amounts of impurities, for example, a sedimentation inhibitor which do not function as pigment, other than the raw material powder, silicone resin, pigment, lower layer coating materials (silicon compound, and the like). However, there is no particular problem as long as these are in a very small amount (5% or less) relative to the total weight of the ferromagnetic-metal-based powder or iron-based powder.

The iron-based powder produced by the aforementioned method can be pressed using a die, etc., after addition of a lubricant, etc., if necessary, and therefore, made to be a compact (powder core). Regarding this pressing, by applying, for example, a high-pressure pressing method in which the pressing pressure is 980 MPa or more; a so-called powder forging method in which the powder is made to be a preliminary body in advance and is subjected to cold forging; a so-called warm pressing method in which the powder and a dieare heated, and the pressing is performed at a predetermined temperature; a die lubrication method in which even a powder containing no lubricant can be pressed without causing galling of a die, and the like by coating the surface of the die, instead of the powder, with a lubricant; and a warm die lubrication pressing method which is a combination of the die lubrication method and the warm pressing method, a high density powder core (powder core density is 7.47 Mg/m³ or more in the case where the pure iron powder is used) can be produced, wherein the powder core density becomes 95% or more of the true density (theoretical density of a ferromagnetic metal, especially a metal primarily containing iron, constituting the raw material powder).

In general, a hole, a so-called pore, is present in the inside of a powder core. It is known that the pore becomes a cause of reduction of the powder core strength. The pore also becomes a cause of degradation of the magnetic characteristics so as to reduce the magnetic flux density, and the like. This is because when the pore is present, a demagnetizing field is generated so as to reduce the magnetic flux density in the powder core. In order to prevent generation of the demagnetizing field and to improve the magnetic characteristics, for example, improvement of magnetic flux density, it is very effective to minimize the size of the pore.

The pore is present between particles in the powder core, and when the powder core density, relative to the true density, is less than 95%, a plurality of pores between adjacent particles form in a continuously connected state, that is, the pores become a so-called open hole. However, when the powder core density becomes 95% or more relative to the true density, the pore present between particles remains in an isolated state, that is, the pore becomes a so-called closed hole. When the pore becomes a closed hole, since the size thereof is remarkably reduced, generation of the demagnetizing field is reduced and improvement of the magnetic characteristics, for example, remarkable improvement of magnetic flux density, can be realized. Therefore, the powder core density is specified to be preferably 95% or more relative to the true density, and more preferably, be 98% or more.

Examples of lubricants include, for example, metal soap, e.g., lithium stearate, zinc stearate, and calcium stearate, or wax, e.g., aliphatic amide. Addition of the lubricant may be omitted depending on the use of the powder core.

In the case where warm pressing or warm die lubrication is performed, when the melting point of the lubricant is lower than a pressing temperature, the lubricant may melt and separate from the powder portion, that is, so-called melt-off of lubricant may occur and, therefore, an effect of the lubricant may be reduced. Consequently, preferably, at least one lubricant having a melting point higher than the pressing temperature is used. In the present invention, a plurality of lubricants may be mixed beforehand, and may be used as a lubricant.

A powder core can be used without annealing. Alternatively, after pressing, in order to relieve strain applied to the iron-based powder during pressing and to reduce hysteresis loss, the body is preferably subjected to a heat treatment for relieving strain (annealing). The time, temperature and atmosphere of the heat treatment after pressing may be appropriately determined in accordance with the uses. Herein, an annealing atmosphere may be any one of an inert gas atmosphere of Ar gas, N₂ gas, etc., a reducing gas atmosphere of hydrogen gas, etc., and vacuum. The dew point of the atmospheric gas may be appropriately determined in accordance with the uses, etc. The temperature raising rate and temperature lowering rate during annealing may be appropriately determined in accordance with the working environment and uses. During raising temperature or lowering temperature, a step for keeping a constant temperature during the annealing process may be provided. A typical range of the annealing temperature is on the order of 400° C. to 1000° C., and a typical range of the annealing time is on the order of 10 minutes to 300 minutes.

The aforementioned powder core produced by pressing using the iron-based powder, , exhibits high insulation property even when annealed at a high temperature at which most organic materials are decomposed.

When the paint containing silicone resin and pigment is added to the raw material powder and these are mixed, the silicone resin and pigment in the paint integrally coat the raw material powder, and after drying, the silicone resin is cured. Consequently, the silicone resin forms a strong coating containing the pigment as a reinforcement filler. Since the surface of the iron-based powder is covered with a coating which is composed of the silicone resin and pigment, and which has a high insulation property, the insulation property of the powder core is improved by a large degree.

It is believed that when the powder core produced using the iron-based powder including the coating having such a high insulation property is annealed, the silicone resin on the surface of the iron-based powder is thermally decomposed and changed into silica and, at the same time, is sintered together with the pigment and iron-based powder so as to form a ceramic-like or vitreous material having a high insulation property and high strength. Therefore, high insulation property and practical strength can be realized even after annealing.

Accordingly, it is assumed that the pigment used in the present invention preferably improves the strength and insulation property of the aforementioned sintered structure. Specifically, it is believed that in order to constitute a coating similar to the fine crystalline of, for example, alumina-silicate glass or mullite, a method, in which alumina, silica, etc., are combined, or materials functioning as fillers in the inside of the sintered structure because of a plate structure like mica and talc and of a high insulation property are combined, and the like is effective.

When the powder, in which the coating containing at least one material selected from the group consisting of silicon compounds, titanium compounds, zirconium compounds, phosphorus compounds, and chromium compounds is formed on the surface, is used as the raw material powder, the insulation property after annealing is further improved.

When the raw material powder is subjected to a surface treatment for forming a coating containing at least one material selected from the group consisting of silicon compounds, titanium compounds, zirconium compounds, phosphorus compounds, and chromium compounds, reaction products are densely generated on the surface of the raw material powder and, therefore, insulation property among the raw material powder is remarkably improved. Furthermore, the wettability and adhesion between the raw material powder and the coating composed of the silicone resin and pigment are remarkably improved due to the reaction products (coating) formed on the surface. The coating composed of the silicone resin and pigment becomes further uniform due to improvement of the wettability. The adhesion and improvement of the wettability of the coating is maintained even after annealing. Accordingly, it is assumed that a further higher insulation property after annealing is achieved by applying a surface treatment to the raw material powder in advance so as to form the lower layer coating.

### EXAMPLES

### Example 1

A paint, in which a silicone resin and pigment were added to a solvent in order that the content thereof became as shown in Tables 2-1, 2-2 and 2-3, was added to a raw material powder primarily containing iron, and agitation and mixing were performed. The resulting powder was subjected to a drying treatment.

As the raw material powder primarily containing iron, (a) an iron powder “KIP(R)-MG270H” manufactured by Kawasaki Steel Corporation, (b) an iron powder “KIP(R)-304A” manufactured by Kawasaki Steel Corporation, (c) an oblate powder processed with a pulverizer from (a) the iron powder “KIP(R)-MG270H” manufactured by Kawasaki Steel Corporation, and (d) a sendust powder, each having a particle size distribution shown in Table 1, were used. Powders produced by controlling the particle size of (b) the iron powder “KIP(R)-304A” were used as (e) and (f).

As the silicone resin, SR-2410, SR-2400, SH805, SH2115 and R-925 manufactured by Dow Corning Toray Silicone Co., Ltd., were used.

As the pigment, at least one powder was used. The powder to be used was chosen from powders of silica(silicon oxide), alumina(corundum type), zirconia(zirconium oxide), titania(rutile type), mullite, forsterite, silicon nitride, aluminum nitride, silicon carbide, talc, organic bentonite, iron oxide, chromium oxide, copper oxide, frit glass for enamel(01-4102P manufactured by FERRO ENAMELS (JAPAN) LIMITED), and mica. In example 1-54, a colloidal silica which was dispersed in methyl-ethyl ketone solvent (the concentration of the silica in the solution was 20% by mass.) was used as a silica. In example 1-55, a collidal silica which was dispersed in water solvent (the concentration of the silica in the solution was 20% by mass.) was used as a silica. In example 1-56, a collidal alumina-silica in which 90% by mass of a colloidal silica and 10% by mass of a colloidal alumina with 3% of an acetic acid were dispersed in water solvent (the concentration of the silica in the solution was 20% by mass) was used as a silica.

Xylen was used as the solvent. However in Example 1-54, the mixed solvent of 50% by mass of xylen and 50% by mass of methyl-ethyl ketone was used. In Example 1-55 and 1-56, water was used as the solvent. Regarding the paint, the total content of the pigment and the silicone resin in the solution was adjusted to be 20% by mass.

A Henschel mixer or rolling fluidized granulator was used for agitation and mixing of the pigment, raw material powder primarily containing iron, and paint.

In the case where the Henschel mixer was used, the whole paint was added to the raw material powder and thereafter, agitation and mixing were performed. The mixing time was specified to be 400 seconds. The adhesion amount of the coating was adjusted to the value shown in Tables 3-1, 3-2 and 3-3 by changing the addition amount of the paint.

In the case where the rolling fluidized granulator was used, the raw material powder was fluidized in a fluidized tank and, thereafter, the paint was added to the raw material powder through a spray nozzle. The paint was added at a rate of 20 g per minute. After addition of the paint was completed, fluidization was performed for 1,200 seconds for the drying treatment. The adhesion amount of the coating was adjusted at the value shown in Tables 3-1 to 3-3 by changing the spraying amount of the paint.

Regarding drying treatment, after agitation and mixing, standing was performed at room temperature for 10 hours, and heating and drying were performed at 250° C. for 120 minutes (this also serves as curing treatment of the thermosetting type silicone resin, and as a treatment for ensuring curing and adhesion of the room temperature curing type silicone resin).

A lubricant was added to the iron-based powder including a coating on the surface produced as described above, and mixing was performed. Zinc stearate was used as the lubricant. The addition amount of the lubricant was specified to be 0.25 parts by weight relative to 100 parts by weight of the iron-based powder.

Addition and mixing of the lubricant was performed according to the following steps. The iron-based powder was put in a bag. A predetermined amount of lubricant was added into the bag. Thereafter, the inlet of the bag was closed tightly, and the whole bag was vibrated in order that the lubricant was uniformly mixed with the whole iron-based powder. The resulting powder mixture was pressed at a pressing pressure shown in Tables 3-1 to 3-3. Next, compacts of a ring test piece (outer diameter of 38 mm, inner diameter of 25 mm, and height of 6.2 mm) for magnetic measurement and a rectangular parallelepiped test piece (width of 10 mm, length of 35 mm, and height of 6.2 mm) for resistivity measurement were produced.

The resulting compacts were subjected to annealing at 800° C. for 1 hour in a nitrogen atmosphere. Regarding Example 1-19, annealing was not performed.

Regarding these compacts (powder core) after annealing, the powder core density, resistivity, inductance at 10 kHz, and core loss at 10 kHz and 0.1 T were measured. Furthermore, a manual bending test was performed.

The powder core density was determined by calculation based on the measured values of mass and volume of the test piece. The resistivity was measured by a four-terminal method using the rectangular parallelepiped test piece.

The measurement of inductance was performed with a LCR meter (HP4284A) manufactured by Agilent Technologies using a coil made from 11 turns of formal covered wire 0.6 mm in diameter wound on the ring test piece. AC relative initial permeability μ_{iAC} was determined by calculation based on the obtained inductance value.

The core loss was measured with a B-H Analyzer (E5060A) manufactured by Agilent Technologies using a coil made from 40 turns at each of primary side and secondary side of formal covered wire 0.6 mm in diameter wound on the ring test piece.

The manual bending test is a test in which the test piece for resistivity measurement is manually bended, and test pieces manually broken were evaluated to be not usable for the powder core.

The results thereof are shown in Tables 3-1, 3-2 and 3-3.

TABLE 1

| Powder primarily containing | | | | | | | |
|---|---|---|---|---|---|---|---|
| iron | | Particle size analysis (% by mass) | | | | | |
| No | Sort | <45 μm | 45-63 μm | 63-75 μm | 75-106 μm | 106-150 μm | 150-180 μm |
| a | KIP-MG270H | 15 | 10 | 5 | 20 | 42 | 8 |
| b | KIP-304A | 25 | 20 | 10 | 30 | 12 | 3 |
| c | Oblate powder processed | 8 | 12 | 5 | 20 | 25 | 30 |
| | from a | | | | | | |
| d | Sendust | 40 | 25 | 10 | 15 | 9 | 1 |
| e | KIP-304A+#100 | 0 | 0 | 0 | 0 | 84 | 16 |
| f | KIP-304A−#200 | 45 | 35 | 20 | 0 | 0 | 0 |

TABLE 2-1

| | | Paint** | | | | | | | | | | | | | | | | | | |
|---|---|---|---|---|---|---|---|---|---|---|---|---|---|---|---|---|---|---|---|---|
| | | | | Pigment | | | | | | | | | | | | | | | | |
| | Raw material | Silicone resin* | | | | | Aluminum | Silicon | Silicon | | | Organic | | | Iron | Chromium | Copper | Frit | | Total |
| Category | powder*** | Sort | Content | Zirconia | Silica | Mullite | nitride | nitride | carbide | Alumina | Forsterite | bentonite | Talc | Titania | oxide | oxide | oxide | glass | Mica | Content* |
| EX 1-1 | a | SR2410 | 50 | 50 | | | | | | | | | | | | | | | | 50 |
| EX 1-2 | a | SR2410 | 50 | | 50 | | | | | | | | | | | | | | | 50 |
| EX 1-3 | a | SR2410 | 40 | 40 | 10 | 10 | | | | | | | | | | | | | | 60 |
| EX 1-4 | b | SR2410 | 50 | | 30 | 20 | | | | | | | | | | | | | | 50 |
| EX 1-5 | b | SR2410 | 40 | | | | 40 | 10 | 10 | | | | | | | | | | | 60 |
| EX 1-6 | a | SR2410 | 40 | 8 | 4 | | | 8 | | 40 | | | | | | | | | | 60 |
| EX 1-7 | a | SR2410 | 40 | 8 | 4 | | | 8 | | 40 | | | | | | | | | | 60 |
| EX 1-8 | c | SR2410 | 40 | 8 | 4 | | | 8 | | 40 | | | | | | | | | | 60 |
| EX 1-9 | a | SR2410 | 40 | 8 | 2 | | | 8 | | | 40 | 2 | | | | | | | | 60 |
| EX 1-10 | a | SR2410 | 40 | | | | | | | 36 | | 2 | 8 | 8 | 2 | 2 | 2 | | | 60 |
| EX 1-11 | a | SR2410 | 40 | | 8 | | | 8 | | 36 | | | 6 | | | | 2 | | | 60 |
| EX 1-12 | a | SR2410 | 40 | 36 | 8 | | | | | | 10 | | | | 6 | | | | | 60 |
| EX 1-13 | a | SR2410 | 40 | | | | 2 | 8 | | 36 | | | 8 | | | 6 | | | | 60 |
| EX 1-14 | a | SR2410 | 40 | 2 | | | 36 | | 8 | | | | | 8 | 2 | 2 | 2 | | | 60 |
| EX 1-15 | c | SR2410 | 40 | | | | | | | 36 | | 2 | 8 | 8 | 2 | 2 | 2 | | | 60 |
| EX 1-16 | b | SR2410 | 40 | 2 | 2 | | 36 | | 8 | | | | | 8 | 2 | 2 | | | | 60 |
| EX 1-17 | d | SR2410 | 40 | | | | | | | 36 | | 2 | 8 | 8 | 2 | 2 | 2 | | | 60 |
| EX 1-18 | a | SR2410 | 40 | | | | | | | 36 | | 2 | 8 | 8 | 2 | 2 | 2 | | | 60 |
| EX 1-19 | a | SR2410 | 40 | | | | | | | 36 | | 2 | 8 | 8 | 2 | 2 | 2 | | | 60 |
| EX 1-20 | a | SH805 | 40 | | 8 | | | | | 40 | | | 8 | 2 | 2 | | | | | 60 |
| EX 1-21 | a | SR2115 | 40 | | 8 | | | | | 40 | | | 8 | 2 | 2 | | | | | 60 |
| EX 1-22 | a | SR2115 | 40 | | 8 | | | | | | | | 8 | 2 | 2 | | | 40 | | 60 |
| EX 1-23 | b | SR2410 | 40 | | | | | | | 36 | | 2 | 8 | 8 | 2 | 2 | 2 | | | 60 |

*content is a value relative to the total of silicone resin and pigment (% by mass)
**xylene is used as solvent for paint
***refer to Table 1
EX: Example
CE: Comparative example

TABLE 2-2

| | | Paint** | | | | | | | | | | | | | | | | | | |
|---|---|---|---|---|---|---|---|---|---|---|---|---|---|---|---|---|---|---|---|---|
| | | | | Pigment | | | | | | | | | | | | | | | | |
| | Raw material | Silicone resin* | | | | | Aluminum | Silicon | Silicon | | | Organic | | | Iron | Chromium | Copper | Frit | | Total |
| Category | powder*** | Sort | Content | Zirconia | Silica | Mullite | nitride | nitride | carbide | Alumina | Forsterite | bentonite | Talc | Titania | oxide | oxide | oxide | glass | Mica | Content* |
| CE 1-1 | a | SR2410 | 100 | | | | | | | | | | | | | | | | | 0 |
| CE 1-2 | a | — | 0 | | | | | | | 100 | | | | | | | | | | 100 |
| CE 1-3 | a | Epoxy resin | 60 | | | | | | | 36 | | 2 | 8 | 8 | 2 | 2 | 2 | | | 40 |
| CE 1-4 | a | Silica sol | 100 | | | | | | | | | | | | | | | | | 0 |
| CE 1-5 | a | Silica sol | 40 | | | | | | | 36 | | 2 | 8 | 8 | 2 | 2 | 2 | | | 60 |
| CE 1-6 | a | Phenol | 40 | | | | | | | 36 | | 2 | 8 | 8 | 2 | 2 | 2 | | | 60 |
| | | resin | | | | | | | | | | | | | | | | | | |
| EX 1-24 | b | SR2410 | 35 | | | | | | | 54 | | | 11 | | | | | | | 65 |
| EX 1-25 | e | SR2410 | 35 | | | | | | | 54 | | | 11 | | | | | | | 65 |
| EX 1-26 | f | SR2410 | 35 | | | | | | | 54 | | | 11 | | | | | | | 65 |
| EX 1-27 | e | SR2410 | 20 | | | | | | | 40 | | | 40 | | | | | | | 80 |
| EX 1-28 | f | SR2410 | 20 | | | | | | | 66 | | | 14 | | | | | | | 80 |
| EX 1-29 | f | SR2410 | 20 | | | | | | | 40 | | | 40 | | | | | | | 80 |
| EX 1-30 | e | SR2410 | 20 | | | | | | | 20 | | | 60 | | | | | | | 80 |
| EX 1-31 | f | SR2410 | 20 | | | | | | | 20 | | | 60 | | | | | | | 80 |
| EX 1-32 | b | SR2410 | 20 | | 10 | | | | | | | | 60 | | | | | | 10 | 80 |
| EX 1-33 | e | SR2410 | 5 | | 48 | | | | | | | | | | | | | | 47 | 95 |
| EX 1-34 | a | SR2410 | 5 | | 48 | | | | | 47 | | | | | | | | | | 95 |
| EX 1-35 | b | SR2410 | 5 | | 24 | | | | | 47 | | | | | | | | | 24 | 95 |
| EX 1-36 | b | SR2410 | 1 | | 74 | | | | | | | | | | | | | | 25 | 99 |
| EX 1-37 | f | SR2410 | 1 | | 37 | | | | | 31 | | | 31 | | | | | | | 99 |
| EX 1-38 | f | SR2410 | 1 | | | | | | | | | | 74 | | | | | | 25 | 99 |
| EX 1-39 | f | SR2410 | 0.8 | | | | | | | 25 | | | 74.2 | | | | | | | 99.2 |
| EX 1-40 | b | SR2410 | 50 | | 46 | | | | | 4 | | | | | | | | | | 50 |

*content is a value relative to the total of silicone resin and pigment (% by mass)
**xylene is used as solvent for paint
***refer to Table 1
EX: Example
CE: Comparative example

TABLE 2-3

Paint**

Pigment

| | | | | | | | | | | | | | | | | | | | | |
|---|---|---|---|---|---|---|---|---|---|---|---|---|---|---|---|---|---|---|---|---|
| | Raw material | Silicone resin* | | | | Aluminum | Silicon | Silicon | | | Organic | | | Iron | Chromium | Copper | Frit | | Total | |
| Category | powder*** | Sort | Content | Zirconia | Silica | Mullite | nitride | nitride | carbide | Alumina | Forsterite | bentonite | Talc | Titania | oxide | oxide | oxide | glass | Mica | Content* |

| | | | | | | | | |
|---|---|---|---|---|---|---|---|---|
| EX 1-41 | b | SR2410 | 50 | 30 | 10 | | 10 | 50 |
| EX 1-42 | b | SR2410 | 50 | | 40 | | 10 | 50 |
| EX 1-43 | b | SR2410 | 40 | 5 | 55 | | | 60 |
| EX 1-44 | b | SR2410 | 35 | | 54 | 11 | | 65 |
| EX 1-45 | b | SR2410 | 35 | | 54 | 11 | | 65 |
| EX 1-46 | e | SR2410 | 35 | | 54 | 11 | | 65 |
| EX 1-47 | b | SR2410 | 20 | | 40 | 40 | | 80 |
| EX 1-48 | b | SR2410 | 20 | | 40 | 40 | | 80 |
| EX 1-49 | b | SR2410 | 20 | | 40 | 40 | | 80 |
| EX 1-50 | e | SH805 | 20 | | 40 | 40 | | 80 |
| EX 1-51 | f | SR2400 | 20 | | 20 | 60 | | 80 |
| EX 1-52 | b | Sh805 | 20 | | 40 | 40 | | 80 |
| EX 1-53 | b | SR2400 | 20 | | 40 | 40 | | 80 |
| ****EX 1-54 | b | SR2400 | 20 | 80 | | | | 80 |
| *****EX 1-55 | b | R-925 | 20 | 80 | | | | 80 |
| ******EX 1-56 | b | R-925 | 20 | 80 | | | | 80 |

*content is a value relative to the total of silicone resin and pigment (% by mass)
**xylene is used as solvent for paint
***refer to Table 1
EX: Example
CE: Comparative example
****In Example 1-54, the mixed solvent of 50% by mass of xylen and 50% by mass of methyl-ethyl ketone is uder as solvent for paint. A colloidal silica which was dispersed in methy-ethyl ketone solvent was used as a silica
*****In Example 1-55, water is used as solvent for paint. A collidal silica which was dispersed in water solvent was used as a silica.
******In Example 1-56, water is used as solvent for paint. A collidal alumina-silica in which 90% by mass of a collidal silica and 10% by mass of a collidal alumina with 3% of an acetic acid was dispersed in water solvent was used a solica.

TABLE 3-1

| | | | | | Powder core | | | | | | | |
|---|---|---|---|---|---|---|---|---|---|---|---|---|
| | Iron-based powder | | | | | | Test results | | | | | |
| | | | Coating | | | | | | Value | AC | | |
| | | | Silicone | | | | | | relative | relative | Core | |
| | Mixing Method | | resin/ | Adhesion | Pressing | | | | to true | initial | loss | Manual |
| | Apparatus | Time | Pigment | amount | pressure | | Resistivity | Density | density | permeability | (10 kHz, 0.1T) | bending |
| Category | used | (s) | ratio R | (% by mass) | (MPa) | Annealing | (μΩm) | (Mg/m³) | (%) | (μ_{IAC}) | (W/kg) | test |
| EX 1-1 | Henachel | 400 | 1 | 0.5 | 686 | Performed | 217 | 6.98 | 89 | 72 | 38.0 | Not |
| | mixer | | | | | | | | | | | bended |
| EX 1-2 | | | 1 | 1 | | | 327 | 6.81 | 87 | 71 | 31.3 | Not |
| | | | | | | | | | | | | bended |
| EX 1-3 | | | 0.67 | 5 | | | 630 | 6.37 | 81 | 56 | 30.3 | Not |
| | | | | | | | | | | | | bended |
| EX 1-4 | | | 1 | 10 | | | 1201 | 5.38 | 68 | 32 | 27.3 | Not |
| | | | | | | | | | | | | bended |
| EX 1-5 | | | 0.67 | 10 | | | 1301 | 5.37 | 68 | 32 | 25.6 | Not |
| | | | | | | | | | | | | bended |
| EX 1-6 | | | 0.67 | 5 | | | 1048 | 6.82 | 87 | 71 | 24.7 | Not |
| | | | | | | | | | | | | bended |
| EX 1-7 | | | 0.67 | 10 | | | 2398 | 5.63 | 72 | 35 | 24.7 | Not |
| | | | | | | | | | | | | bended |
| EX 1-8 | | | 0.67 | 15 | | | 2403 | 6.08 | 77 | 65 | 24.7 | Not |
| | | | | | | | | | | | | bended |
| EX 1-9 | | | 0.67 | 10 | | | 2498 | 5.42 | 69 | 33 | 24.7 | Not |
| | | | | | | | | | | | | bended |
| EX 1-10 | | | 0.67 | 5 | | | 1835 | 6.43 | 82 | 56 | 22.9 | Not |
| | | | | | | | | | | | | bended |
| EX 1-11 | | | 0.67 | 10 | | | 3467 | 5.37 | 68 | 33 | 22.5 | Not |
| | | | | | | | | | | | | bended |
| EX 1-12 | | | 0.67 | 15 | | | 5798 | 5.08 | 65 | 31 | 22.3 | Not |
| | | | | | | | | | | | | bended |
| EX 1-13 | | | 0.67 | 20 | | | 8413 | 4.88 | 62 | 31 | 22.2 | Not |
| | | | | | | | | | | | | bended |
| EX 1-14 | | | 0.67 | 25 | | | 9413 | 4.84 | 62 | 31 | 22.2 | Not |
| | | | | | | | | | | | | bended |
| EX 1-15 | | | 0.67 | 15 | | | 2985 | 6.42 | 82 | 74 | 22.6 | Not |
| | | | | | | | | | | | | bended |
| EX 1-16 | | | 0.67 | 15 | | | 3029 | 5.07 | 65 | 30 | 23.6 | Not |
| | | | | | | | | | | | | bended |
| EX 1-17 | | | 0.67 | 10 | | | 10213 | 4.36 | 62 | 40 | 1.2 | Not |
| | | | | | | | | | | | | bended |
| EX 1-18 | Rolling fluidized | | 0.67 | 5 | | | 4572 | 6.35 | 81 | 59 | 21.3 | Not |
| | granulator | | | | | | | | | | | |
| | | | | | | | | | | | | bended |
| EX 1-19 | Henschel | 400 | 0.67 | 10 | | None | 300000 | 5.42 | 69 | 30 | 45.0 | Not |
| | mixer | | | | | | | | | | | bended |
| EX 1-20 | | | 0.67 | 0.01 | 1176 | Performed | 103 | 7.62 | 97 | 85 | 43.0 | Not |
| | | | | | | | | | | | | bended |
| EX 1-21 | | | 0.67 | 0.1 | | | 120 | 7.53 | 96 | 81 | 42.0 | Not |
| | | | | | | | | | | | | bended |
| EX 1-22 | | | 0.67 | 10 | 686 | | 2013 | 5.85 | 74 | 40 | 27.8 | Not |
| | | | | | | | | | | | | bended |
| EX 1-23 | | | 0.67 | 0.5 | 1176 | | 275 | 7.59 | 97 | 117 | 32.5 | Not |
| | | | | | | | | | | | | bended |

*no pigment
EX: Example
CE: Comparative example

TABLE 3-2

| | | | | | Powder core | | | | | | | |
|---|---|---|---|---|---|---|---|---|---|---|---|---|
| | Iron-based powder | | | | | | Test results | | | | | |
| | | | Coating | | | | | | Value | AC | | |
| | | | Silicone | | | | | | relative | relative | | |
| | Mixing method | | resin/ | Adhesion | Pressing | | | | to true | initial | Core loss | Manual |
| | Apparatus | Time | Pigment | amount | pressure | | Resistivity | Density | density | permeability | (10 kHz, 0.1T) | bending |
| Catergor | used | (s) | ratio R | (% by mass) | (MPa) | Annealing | (μΩm) | (Mg/m³) | (%) | (μ_{IAC}) | (W/kg) | test |
| CE 1-1 | Henschel | 400 | — * | 10 | 686 | Performed | 2.0 | 5.38 | 68 | 21 | Not | Not |
| | mixer | | | | | | | | | | measured | bended |
| CE 1-2 | | | 0 | 15 | | | 0.1 | 5.08 | 65 | 21 | Not | Not |
| | | | | | | | | | | | measured | bended |
| CE 1-3 | | | 0.67 | 15 | | | 0.3 | 5.12 | 65 | 21 | Not | Not |
| | | | | | | | | | | | measured | bended |
| CE 1-4 | | | — * | 5 | | | 15 | 6.43 | 82 | Not | Not | Broken |
| | | | | | | | | | | measured | measured | |
| CE 1-5 | | | 0.67 | 10 | | | 100 | 4.28 | 54 | Not | Not | Broken |
| | | | | | | | | | | measured | measured | |
| CE 1-6 | | | 0.67 | 5 | | | 0.2 | 5.13 | 65 | 20 | Not | Not |
| | | | | | | | | | | | measured | bended |
| EX 1-24 | Henschel | 400 | 0.54 | 1 | 686 | Performed | 453 | 7.13 | 91 | 81 | 28.2 | Not |
| | mixer | | | | | | | | | | | bended |
| EX 1-25 | | | 0.54 | 2 | | | 860 | 6.84 | 87 | 69 | 34.1 | Not |
| | | | | | | | | | | | | bended |
| EX 1-26 | | | 0.54 | 5 | | | 871 | 6.53 | 83 | 56 | 36.2 | Not |
| | | | | | | | | | | | | bended |
| EX 1-27 | | | 0.25 | 0.1 | 980 | | 165 | 7.52 | 96 | 102 | 35.5 | Not |
| | | | | | | | | | | | | bended |
| EX 1-28 | | | 0.25 | 0.5 | 686 | | 950 | 7.21 | 92 | 104 | 31.4 | Not |
| | | | | | | | | | | | | bended |
| EX 1-29 | | | 0.25 | 0.5 | | | 1250 | 7.24 | 92 | 104 | 26.1 | Not |
| | | | | | | | | | | | | bended |

| | | | | | | | | | | |
|---|---|---|---|---|---|---|---|---|---|---|
| EX 1-30 | Rolling | 0.25 | 0.1 | 1176 | 152 | 7.62 | 97 | 128 | 40.5 | Not |
| | fluidized | | | | | | | | | bended |
| | granulator | | | | | | | | | |
| EX 1-31 | | 0.25 | 0.5 | 686 | 2342 | 7.24 | 92 | 104 | 27.3 | Not |
| | | | | | | | | | | bended |
| EX 1-32 | | 0.25 | 0.2 | 980 | 546 | 7.50 | 95 | 123 | 31.2 | Not |
| | | | | | | | | | | bended |
| EX 1-33 | | 0.05 | 0.1 | 1176 | 120 | 7.63 | 97 | 129 | 34.5 | Not |
| | | | | | | | | | | bended |
| EX 1-34 | | 0.05 | 0.5 | 686 | 2342 | 7.12 | 91 | 90 | 29.4 | Not |
| | | | | | | | | | | bended |
| EX 1-35 | | 0.05 | 0.2 | 882 | 198 | 7.45 | 95 | 117 | 36.7 | Not |
| | | | | | | | | | | bended |
| EX 1-36 | | 0.01 | 0.1 | 1176 | 81 | 7.61 | 97 | 122 | 48.2 | Not |
| | | | | | | | | | | bended |
| EX 1-37 | | 0.01 | 0.5 | 784 | 342 | 7.32 | 93 | 101 | 28.9 | Not |
| | | | | | | | | | | bended |
| EX 1-38 | | 0.01 | 0.2 | | 125 | 7.40 | 94 | 108 | 35.6 | Not |
| | | | | | | | | | | bended |

* no pigment
EX: Example
CE:Comparative example

TABLE 3-3

| | | | | | Powder core | | | | | | | |
|---|---|---|---|---|---|---|---|---|---|---|---|---|
| | Iron-based powder | | | | | | Test results | | | | | |
| | | | Coating | | | | | | Value | AC | | |
| | | | Silicone | | | | | | relative | relative | | |
| | Mixing method | | resin/ | Adhesion | Pressing | | | | to true | initial | Core loss | Manual |
| | Apparatus | Time | Pigment | amount | pressure | | Resistivity | Density | density | permeability | (10 kHz, 0.1T) | bending |
| Catergory | used | (s) | ratio R | (% by mass) | (MPa) | Annealing | (μΩm) | (Mg/m³) | (%) | (μ_{IAC}) | (W/kg) | test |
| EX 1-39 | Henschel | 400 | 0.008 | 1 | 686 | Performed | 321 | 7.10 | 90 | 82 | 31.3 | Not |
| | mixer | | | | | | | | | | | bended |
| EX 1-40 | | | 1.00 | 1 | | | 380 | 6.92 | 88 | 70 | 31.3 | Not |
| | | | | | | | | | | | | bended |
| EX 1-41 | | | 1.00 | 1 | | | 324 | 6.91 | 88 | 70 | 34.5 | Not |
| | | | | | | | | | | | | bended |
| EX 1-42 | | | 1.00 | 1 | | | 285 | 6.93 | 88 | 70 | 36.8 | Not |
| | | | | | | | | | | | | bended |
| EX 1-43 | | | 0.67 | 1 | | | 189 | 6.90 | 88 | 70 | 39.0 | Not |
| | | | | | | | | | | | | bended |
| EX 1-44 | Rolling | 0.54 | 0.5 | 1470 | | 43 | 7.66 | 97 | 135 | 63.0 | Not | |
| | fluidized | | | | | | | | | | bended | |
| EX 1-45 | granulator | 0.54 | 0.2 | | | 39 | 7.72 | 98 | 140 | 74.0 | Not | |
| | | | | | | | | | | | bended | |
| EX 1-46 | | 0.54 | 0.5 | | | 81 | 7.69 | 98 | 129 | 52.0 | Not | |
| | | | | | | | | | | | bended | |
| EX 1-47 | | 0.25 | 0.5 | | | 127 | 7.68 | 98 | 125 | 40.0 | Not | |
| | | | | | | | | | | | bended | |
| EX 1-48 | | 0.25 | 0.5 | 980 | | 152 | 7.58 | 96 | 110 | 35.0 | Not | |
| | | | | | | | | | | | bended | |
| EX 1-49 | | 0.25 | 0.5 | 1960 | | 84 | 7.76 | 99 | 154 | 75.3 | Not | |
| | | | | | | | | | | | bended | |
| EX 1-50 | Henschel | 400 | 0.25 | 0.1 | 980 | | 180 | 7.51 | 96 | 120 | 35.8 | Not |
| | mixer | | | | | | | | | | | bended |
| EX 1-51 | | | 0.25 | 0.5 | 686 | | 2380 | 7.24 | 92 | 104 | 27.4 | Not |
| | | | | | | | | | | | | bended |
| EX 1-52 | Rolling | 0.25 | 0.5 | 1470 | | 127 | 7.67 | 98 | 125 | 40.0 | Not | |
| | fluidized | | | | | | | | | | bended | |
| EX 1-53 | granulator | 0.25 | 0.5 | 980 | | 152 | 7.59 | 97 | 110 | 34.9 | Not | |
| | | | | | | | | | | | bended | |
| Ex 1-54 | | 0.25 | 0.5 | 1470 | | 45 | 7.70 | 98 | 128 | 76.3 | Not | |
| | | | | | | | | | | | bended | |
| EX 1-55 | | 0.25 | 0.5 | 1470 | | 58 | 7.69 | 98 | 130 | 71.0 | Not | |
| | | | | | | | | | | | bended | |
| EX 1-56 | | 0.25 | 0.5 | 1470 | | 79 | 7.71 | 98 | 131 | 65.3 | Not | |
| | | | | | | | | | | | bended | |

*no pigment
EX: Example
CE: Comparative example

In each Example, a powder core having a high resistivity and reduced core loss is produced.

Example 1-6 in which alumina was primarily used as pigment shows a high resistivity and reduced core loss compared to those of Example 1-3 in which the same amount of pigment was added. Example 1-10 in which alumina, talc, titania, organic bentonite, iron oxide, chromium oxide, and copper oxide were used as pigment shows a high resistivity and reduced core loss compared to those of Example 1-3 and Example 1-6 in which the same amount of pigment was added. Example 1-17 in which a sendust powder was used as the iron-based powder shows a high resistivity and reduced core loss similar to those of Example 1-10 in which the same sort of paint was used. Therefore, it is clear that the present invention is also effective regarding an alloy powder. Example 1-18 in which the paint was added by a spraying method using a rolling fluidized granulator shows a high resistivity and reduced core loss compared to those of Example 1-10 in which the same amount of the same paint was added and, therefore, it is clear that the spraying method is effective. Example 1-19 in which annealing was not performed shows a remarkably high resistivity but high core loss compared to those of Example 1-11 in which annealing was performed.

In Example 1-28 and Example 1-29, test pieces were produced under the same condition except for the composition of the paint for the use. Example 1-29, in which the ratio of talc is larger, shows a higher resistivity and lower core loss. Consequently, it is clear that when the ratio of talc in the paint composition is increased, the resistivity is increased and the core loss is reduced.

On the other hand, each of Comparative examples which is outside of the scope of the present invention shows remarkably reduced resistivity. Herein, the resistivity of iron is on the order of 0.1 μΩm.

Each of Comparative example 1-1, in which only silicone resin was added, and Comparative example 1-2, in which only pigment was added, showed remarkably reduced resistivity. Furthermore, core loss was increased by a large degree and, therefore, could not be measured. Regarding each of Comparative example 1-3, in which an epoxy resin was used instead of the silicone resin, and Comparative example 1-6, in which a phenol resin was used instead of the silicone resin, the resistivity after annealing was reduced by a large degree, and the core loss was remarkably increased and, therefore, could not be measured. Regarding each of Comparative examples 1-4 and 1-5 in which silica sol was used, the test piece was brittle, and could be manually bended. The ring was also brittle and winding could not be performed. Consequently, the magnetic characteristics could not be examined.

### Example 2

As the raw material powder primarily containing iron, an iron powder “KIP(R)-304A” manufactured by Kawasaki Steel Corporation, shown in Table 1 (No. b) was used. This raw material powder was subjected to a surface treatment so as to form beforehand a coating containing the compound (material) shown in Table 4-1 and 4-2 as a lower layer coating, and was made to be a raw material powder for the succeeding step. The surface treatment for forming the lower layer coating was performed by the steps of adding or spraying a solution containing respective compounds shown in Table 4-1 and 4-2 to the raw material powder, agitating and mixing, standing for 24 hours in a draft, and drying. Alternatively, in Example 2-36, 37, 38, after addition of the solution was completed, the treament was perfomed by the steps of curing at 350° C. for 10 min in ambient atmosphere and drying at 100° C. for 60 min. The concentration of the compound in the solution was specified to be 5% by mass. The solution was added or sprayed in order that the addition amount of the compound to the raw material powder became the value shown in Table 4-1 and 4-2. For example, when the amount of the compound added to the raw material powder is 0.05% by mass, the amount of the solution added or sprayed to the raw material powder becomes 1% by mass. However, in Example 2-32, dilution was not performed, and a silane compound was added to the raw material powder with no solvent and mixing was performed.

A Henschel mixer or rolling fluidized granulator was used for agitation and mixing of the raw material powder and a solution containing various compounds.

In the case where the Henschel mixer was used, the whole solution containing various compounds was added to the raw material powder and, thereafter, agitation and mixing were performed. The mixing time was specified to be 400 seconds. The adhesion amount of the coating was adjusted at the value shown in Table 6 by changing the amount of the solution added.

In the case where the rolling fluidized granulator was used, the raw material powder was fluidized in a fluidized tank and, thereafter, the solution was added to the raw material powder through a spray nozzle. After addition of the solution was completed, fluidization was performed for 1,200 seconds in order to dry. The adhesion amount of the coating was adjusted at the value shown in Table 6 by changing the spraying amount of the solution.

In a manner similar to that in Example 1, a paint, in which a silicone resin and pigment were added to a solvent in order that the content thereof became as shown in Table 5-1 and 5-2, was added or sprayed to the raw material powder, in which the coating (lower layer coating) containing the compound shown in Table 4-1 and 4-2 on the surface, and agitation and mixing were performed. A Henschel mixer or rolling fluidized granulator was used for agitation and mixing. The adhesion amount was as shown in Table 6. Each apparatus was operated in a manner similar to that in Example 1.

According to this treatment, a coating (upper layer coating) containing silicone resin and pigment was formed on the aforementioned lower layer coating as the upper layer coating and, therefore, an iron-based powder including the lower layer coating and upper layer coating was produced. An iron-based powder including only a lower layer coating was taken as a comparative example, in which a coating (upper layer coating) containing silicone resin and pigment was not formed.

A lubricant was added to the iron-based powder including the coating on the surface produced as described above, and mixing was performed. Zinc stearate was used as the lubricant. The amount of the lubricant added was specified to be 0.25 parts by weight relative to 100 parts by weight of the iron-based powder.

Addition and mixing of the lubricant was performed according to the following steps. The iron-based powder was put in a bag. A predetermined amount of lubricant was added into the bag. Thereafter, the inlet of the bag was closed tightly, and the whole bag was vibrated in order that the lubricant was uniformly mixed with the whole iron-based powder. The resulting powder mixture was pressed at a pressing pressure shown in Table 6 and, therefore, compacts of a ring test piece (outer diameter of 38 mm, inner diameter of 25 mm, and height of 6.2 mm) for magnetic measurement and a rectangular parallelepiped test piece (width of 10 mm, length of 35 mm, and height of 6.2 mm) for resistivity measurement were produced.

The resulting compacts were subjected to annealing at 800° C. for 1 hour in a nitrogen atmosphere.

Regarding these compacts (powder core) after annealing, similarly to Example 1, the powder core density, resistivity, inductance at 10 kHz, and core loss at 10 kHz and 0.1 T were measured. Furthermore, a manual bending test was performed. The measuring method and the testing method were similar to those in Example 1.

The results thereof are shown in Table 6.

TABLE 4-1

| Raw | Powder | | | | |
|---|---|---|---|---|---|
| material | primarily | Mixing method | | Solution | |
| powder | containing | Apparatus | Time | Sort of compound | |
| No. | iron | used | (s) | (% by mass *) | Solvent |
| A | KIP-304A | Henschel | 400 | γ-aminopropyltriethoxysilane: 0.05 | Ethanol |
| B | | mixer | | Silyl peroxide: 0.05 | |
| C | | | | Tetraisopropyl titanate: 0.05 | |
| D | | | | Tetraisopropyl titanate: 0.025, | |
| | | | | Isopropoxytitanium stearate: 0.025 | |
| E | | | | Tetraisopropyl titanate: 0.02, | |
| | | | | Tetrabutyl titanate: 0.02 | |
| | | | | Tetrastearyl titanate: 0.01 | |
| F | | | | Zirconium alkoxide coupling agent: 0.05 | |
| G | | | | Phosphoric acid: 0.05 | |
| H | | | | Phosphate: 0.05 | |
| I | | | | Organic chromate: 0.05 | |
| J | | Rolling fluidized | | Phosphoric acid: 0.04 | |
| | | granulator | | Aminopropyltriethoxysilane: 0.01 | |
| K | | | | Phosphoric acid: 0.05 | |
| L | | — | — | — | — |

| | | | |
|---|---|---|---|
| M | Rolling fluidized | Methyltrimethoxysilane: 0.1 | Ethanol |
| | granulator | | |
| N | | Methyltrimethoxysilane: 0.5 | |

* relative to the total powder primarily containing iron
** solvent is not used
*** The Mixed solvent in which 95% by mass of ethanol and 5% by mass of water is used as a solvent.
**** This insulating layer forming solution is prepared by mixing 10 pts. wt. of phosphoric acid (as 100% concentration.), 20 pts. wt. potassium bichromate, 5 pts. wt. of ammonium bichromate, 5% of asboric acid, and 0.5 wt % of oxyethylen-oxypropylene, based on 100 pts. wt. of phosphates of Al and water. The concentation of the solution is 5% by mass.
***** This insulating layer forming solution is prepared by mixing 10 pts. wt. of phosphoric acid (as 100% concentrarion.), 20 pts. wt. potassium bichromate, 5 pts. wt. of ammonium bichromate, 5% of asboric acid, and 0.5 wt % of oxyethylen-oxyoropylene, based on 100 pts. wt. of phosphates of Ca and water. The concentration of the solution is 5% by mass.
****** This insulating layer forming solution is prepared by mixing 10 pts. wt. of phosphoric acid (as 100% concentrarion.), 20 pts. wt. potassium bichromate, 5 pts. wt. of ammonium bichromate, 5% of asboric acid, and 0.5 wt % of oxyethylen-oxyoropylene, based on 100 pts. wt. of phosphates of Zn and water. The concentration of the solution is 5% by mass.

TABLE 4-2

| Raw | Powder | | | | |
|---|---|---|---|---|---|
| material | primarily | Mixing method | | Solution | |
| powder | containing | Apparatus | Time | Sort of compound | |
| No. | iron | used | (s) | (% by mass *) | Solvent |
| O | KIP-304A | Rolling fluidized | | Methyltrimethoxysilane: 1.0 | Ethanol |
| | | granulator | | | |
| P | | | | Dimethyldimethoxysilane: 0.05 | |
| Q | | | | Dimethyldimethoxysilane: 0.2 | |
| R | | | | Phenyltrimethoxysilane: 0.5 | |
| S | | | | Phenyltrimethoxysilane: 2.0 | |
| T | | | | Phenyltrimethoxysilane: 0.5 | |
| U | | | | Heptadecatrifluorodecyltrimethoxysilane: 1.0 | Mixed |
| | | | | | Solvent *** |
| V | | | | Ethyl silicate: 1.0 | |
| W | | | | Ethyl silicate after hydrolysis treatment: 0.5 | |
| X | | | | Methyl silicate: 0.1 | |
| Y | | Henachel | 400 | Methyltrimethoxysilane: 0.5 | — ** |
| | | mixer | | | |

| | | | | |
|---|---|---|---|---|
| Z | K1P-304A | Rolling fluidized | Phosphate compound 1:0.1 **** | water |
| | | granulator | | |
| Z1 | K1P-304A | Rolling fluidized | Phosphate compound 2:0.1 ***** | water |
| | | granulator | | |
| Z2 | K1P-304A | Rolling fluidized | Phosphate compound 3:0.1 ****** | water |
| | | granulator | | |

* relative to the total powder primarily containing iron
** solvent is not used
*** The Mixed solvent in which 95% by mass of ethanol and 5% by mass of water is used as a solvent.
**** This insulating layer forming solution is prepared by mixing 10 pts. wt. of phosphoric acid (as 100% concentration.), 20 pts. wt. potassium bichromate, 5 pts. wt. of ammonium bichromate, 5% of asboric acid, and 0.5 wt % of oxyethylen-oxypropylene, based on 100 pts. wt. of phosphates of Al and water. The concentation of the solution is 5% by mass.
***** This insulating layer forming solution is prepared by mixing 10 pts. wt. of phosphoric acid (as 100% concentrarion.), 20 pts. wt. potassium bichromate, 5 pts. wt. of ammonium bichromate, 5% of asboric acid, and 0.5 wt % of oxyethylen-oxyoropylene, based on 100 pts. wt. of phosphates of Ca and water. The concentration of the solution is 5% by mass.
****** This insulating layer forming solution is prepared by mixing 10 pts. wt. of phosphoric acid (as 100% concentrarion.), 20 pts. wt. potassium bichromate, 5 pts. wt. of ammonium bichromate, 5% of asboric acid, and 0.5 wt % of oxyethylen-oxyoropylene, based on 100 pts. wt. of phosphates of Zn and water. The concentration of the solution is 5% by mass.

TABLE 5-1

| | Raw | Paint ** | | | | | | | | | | |
|---|---|---|---|---|---|---|---|---|---|---|---|---|
| | material | | | Pigment | | | | | | | | |
| | powder | Silicone resin * | | | Organic | | | Iron | Chromium | Copper | Total | |
| Catergory | No. *** | Sort | Content | Alumina | bentonite | Talc | Titania | oxide | oxide | oxide | content * | Remark |
| EX 2-1 | A | SR2410 | 40 | 36 | 2 | 8 | 8 | 2 | 2 | 2 | 60 | |
| EX 2-2 | B | SR2410 | 40 | 36 | 2 | 8 | 8 | 2 | 2 | 2 | 60 | |
| EX 2-3 | C | SR2410 | 40 | 36 | 2 | 8 | 8 | 2 | 2 | 2 | 60 | |
| EX 2-4 | D | SR2410 | 40 | 36 | 2 | 8 | 8 | 2 | 2 | 2 | 60 | |
| EX 2-5 | E | SR2410 | 40 | 36 | 2 | 8 | 8 | 2 | 2 | 2 | 60 | |
| EX 2-6 | F | SR2410 | 40 | 36 | 2 | 8 | 8 | 2 | 2 | 2 | 60 | |
| EX 2-7 | G | SR2410 | 40 | 36 | 2 | 8 | 8 | 2 | 2 | 2 | 60 | |
| EX 2-8 | H | SR2410 | 40 | 36 | 2 | 8 | 8 | 2 | 2 | 2 | 60 | |
| EX 2-9 | I | SR2410 | 40 | 36 | 2 | 8 | 8 | 2 | 2 | 2 | 60 | |
| EX 2-10 | J | SR2410 | 40 | 36 | 2 | 8 | 8 | 2 | 2 | 2 | 60 | |
| EX 2-11 | K | SR2410 | 40 | 36 | 2 | 8 | 8 | 2 | 2 | 2 | 60 | |
| EX 2-12 | L | SR2410 | 40 | 36 | 2 | 8 | 8 | 2 | 2 | 2 | 60 | Phosphoric acid: 0.05 **** |
| EX 2-13 | G | SR2410 | 20 | 66 | | 14 | | | | | 80 | |
| EX 2-14 | A | SR2410 | 20 | 40 | | 40 | | | | | 80 | |
| EX 2-15 | K | SR2410 | 20 | 40 | | 40 | | | | | 80 | |
| EX 2-16 | C | SR2410 | 10 | 76 | | 14 | | | | | 90 | |
| CE 2-1 | G | — | — | | | | | | | | 0 | |
| CE 2-2 | A | — | — | | | | | | | | 0 | |

* content is a value relative to the total of silicone resin and pigment (% by mass)
** xylene is used as solvent for paint
*** refer to Table 4-1 and 4-2
**** content relative to the total iron-based powder (% by mass)
***** $1: Silicon compound (methyltrimethoxysilane) $2: Silicon compound (dimethyldimethoxysilane)
EX: Example
CE: Comparative example

TABLE 5-2

| | | Paint ** | | | | | | | | | | |
|---|---|---|---|---|---|---|---|---|---|---|---|---|
| | Raw material | | | Pigment | | | | | | | | |
| | powder No. | Silicone resin * | | | Organic | | | Iron | Chromium | Copper | Total | |
| Category | *** | Sort | Content | Alumina | bentonite | Talc | Titania | oxide | oxide | oxide | content * | Remark |
| EX 2-17 | M | SR2410 | 20 | 40 | | 40 | | | | | 80 | |
| BX 2-18 | N | SR2410 | 20 | 40 | | 40 | | | | | 80 | |
| EX 2-19 | O | SR2410 | 20 | 40 | | 40 | | | | | 80 | |
| EX 2-20 | O | SR2410 | 20 | 40 | | 40 | | | | | 80 | |
| EX 2-21 | P | SR2410 | 20 | 40 | | 40 | | | | | 80 | |
| EX 2-22 | Q | SR2410 | 20 | 40 | | 40 | | | | | 80 | |
| EX 2-23 | R | SR2410 | 20 | 40 | | 40 | | | | | 80 | |
| EX 2-24 | S | SR2410 | 20 | 40 | | 40 | | | | | 80 | |
| EX 2-25 | T | SR2410 | 20 | 40 | | 40 | | | | | 80 | |
| EX 2-26 | U | SR2410 | 20 | 40 | | 40 | | | | | 80 | |
| EX 2-27 | L | SR2410 | 20 | 40 | | 40 | | | | | 80 | $1:0.5***** |
| EX 2-28 | L | SR2410 | 20 | 40 | | 40 | | | | | 80 | $2:1.0***** |
| EX 2-29 | V | SR2410 | 20 | 40 | | 40 | | | | | 80 | |
| EX 2-30 | W | SR2410 | 20 | 40 | | 40 | | | | | 80 | |
| EX 2-31 | X | SR2410 | 20 | 40 | | 40 | | | | | 80 | |
| EX 2-32 | Y | SR2410 | 20 | 40 | | 40 | | | | | 80 | |
| EX 2-33 | R | SR2400 | 20 | 40 | | 40 | | | | | 80 | |
| EX 2-34 | S | SH805 | 20 | 40 | | 40 | | | | | 80 | |
| EX 2-35 | V | SH805 | 20 | 40 | | 40 | | | | | 80 | |
| EX 2-36 | Z | SR2410 | 20 | 40 | | 40 | | | | | 80 | |
| EX 2-37 | Z1 | SR2410 | 20 | 40 | | 40 | | | | | 80 | |
| EX 2-38 | Z2 | SR2410 | 20 | 40 | | 40 | | | | | 80 | |

* content is a value relative to the total of silicone resin and pigment (% by mass)
** xylene is used as solvent for paint
*** refer to Table 4-1 and 4-2
**** content relative to the total iron-based powder (% by mass)
***** $1: Silicon compound (methyltrimethoxysilane) $2: Silicon compound (dimethyldimethoxysilane)
EX: Example CE: Comparative example

TABLE 6

| | Iron-based powder | | | | | | | Powder core | | | | | | | |
|---|---|---|---|---|---|---|---|---|---|---|---|---|---|---|---|
| | | Coating | | | | | | | | | | | | | |
| | | Lower layer | | Upper layer | | | | | | Test results | | | | | |
| | Raw | | Adhesion | Mixing Method | | Silicone resin/ | Adhesion | Pressing | | | | Value rela- | AC relative | Core loss | Manual |
| | material | Sort of | amount | Apparatus | Time | Pigment | amount | pressure | | Resistivity | Density | tive to true | initial permea- | (10 kHz, 0.1 | bending |
| Category | powder | coating ** | (% by mass) | used | (s) | ratio R | (% by mass) | (MPa) | Annealing | (μm) | (Mg/m³) | density (%) | bility (μ_{IAC}) | T) (W/kg) | test |
| EX 2-1 | A | Silicon compound | 0.05 | Henschel | 400 | 0.67 | 0.5 | 980 | Performed | 850 | 7.50 | 95 | 85 | 27.5 | Not bended |
| | | | | mixer | | | | | | | | | | | |
| EX 2-2 | B | Silicon compound | 0.05 | | | | | | | 820 | 7.49 | 95 | 86 | 29.8 | Not bended |
| EX 2-3 | C | Titanium compound | 0.05 | | | | | | | 820 | 7.48 | 95 | 84 | 30.2 | Not bended |
| EX 2-4 | D | Titanium compound | 0.05 | | | | | | | 780 | 7.49 | 95 | 86 | 30.4 | Not bended |
| EX 2-5 | E | Titanium compound | 0.05 | | | | | | | 830 | 7.48 | 95 | 85 | 30.8 | Not bended |
| EX 2-5 | F | Zirconium compound | 0.05 | | | | | | | 670 | 7.52 | 96 | 86 | 29.2 | Not bended |
| EX 2-7 | G | Phosphorus compound | 0.05 | | | | | | | 970 | 7.53 | 96 | 92 | 26.1 | Not bended |
| EX 2-8 | H | Phosphorus compound | 0.05 | | | | | | | 840 | 7.52 | 96 | 88 | 28.2 | Not bended |
| EX 2-9 | I | Chromium compound | 0.05 | | | | | | | 760 | 7.49 | 95 | 83 | 30.1 | Not bended |
| EX 2-10 | J | Phosphorus compound + | 0.05 | | | | | | | 1010 | 7.50 | 95 | 91 | 25.6 | Not bended |
| | | Silicon compound | | | | | | | | | | | | | |
| EX 2-11 | K | Phosphorus compound | 0.05 | | | | | | | 1020 | 7.50 | 95 | 90 | 25.4 | Not bended |
| EX 2-12 | L | — | — | | | | | | | 850 | 7.52 | 96 | 89 | 26.1 | Not bended |
| EX 2-13 | G | Phosphorus compound | 0.05 | | | 0.25 | 0.5 | | | 1115 | 7.52 | 96 | 92 | 25.4 | Not bended |
| EX 2-14 | A | Silicon compound | 0.05 | | | | | | | 1250 | 7.50 | 95 | 86 | 23.2 | Not bended |
| EX 2-15 | K | Phosphorus compound | 0.05 | | | | | | | 1540 | 7.50 | 95 | 91 | 21.8 | Not bended |
| EX 2-16 | C | Titanium compound | 0.05 | | | | | | | 970 | 7.49 | 95 | 82 | 29.0 | Not bended |
| CE 2-1 | G | Phosphorus compound | 0.05 | Henschel | 400 | —* | — | 980 | | 0.1 | 7.58 | 96 | 20 | Not | Not bended |
| | | | | mixer | | | | | | | | | | measured | |
| CE 2-2 | A | Silicon compound | 0.05 | | | —* | — | | | 0.08 | 7.55 | 96 | 18 | Not | Not bended |
| | | | | | | | | | | | | | | measured | |
| EX 2-17 | M | Silicon compound | 0.1 | Rolling fluidized | | 0.25 | 0.5 | 686 | | 1240 | 7.24 | 92 | 98 | 35.0 | Not bended |
| | | | | granulator | | | | | | | | | | | |
| EX 2-18 | N | Silicon compound | 0.5 | | | | 0.2 | 1470 | | 210 | 7.70 | 98 | 135 | 39.0 | Not bended |
| EX 2-19 | O | Silicon compound | 1.0 | | | | 0.2 | 1470 | | 290 | 7.69 | 98 | 128 | 34.0 | Not bended |
| EX 2-20 | O | Silicon compound | 1.0 | | | | 0.5 | 1470 | | 1200 | 7.65 | 97 | 124 | 31.0 | Not bended |
| | Iron-based powder | | | | | | | Powder core | | | | | | | |
| | | Coating | | | | | | | | | | | | | |
| | | Lower layer | | Upper layer | | | | | | Test results | | | | | |
| | Raw | | Adhesion | Mixing Method | | Silicone resin/ | Adhesion | Pressing | | | | Value rela- | AC relative | Core loss | Manual |
| | material | Sort of | amount | Apparatus | Time | Pigment | amount | pressure | | Resistivity | Density | tive to true | initial permea- | (10 kHz, 0.1 | bending |
| Category | powder | coating ** | (% by mass) | used | (s) | ratio R | (% by mass) | (MPa) | Annealing | (μΩm) | (Mg/m³) | density (%) | bility (μ_{IAC}) | T) (W/kg) | test |

| | | | | | | | | | | | | | | |
|---|---|---|---|---|---|---|---|---|---|---|---|---|---|---|
| EX 2-21 | P | Silicon compound | 0.1 | Rolling | 0.25 | 1.0 | 980 | Performed | 960 | 7.49 | 95 | 120 | 36.0 | Not bended |
| | | | | fluidized | | | | | | | | | | |
| | | | | granulator | | | | | | | | | | |
| EX 2-22 | Q | Silicon compound | 0.2 | | | 0.5 | 1176 | | 940 | 7.54 | 96 | 124 | 37.2 | Not bended |
| EX 2-23 | R | Silicon compound | 0.5 | | | 0.05 | 1960 | | 120 | 7.80 | 99 | 150 | 48.0 | Not bended |
| EX 2-24 | S | Silicon compound | 2.0 | | | 2.0 | 686 | | 12310 | 6.86 | 87 | 75 | 31.0 | Not bended |
| EX 2-25 | T | Silicon compound | 0.5 | | | 5.0 | 686 | | 23500 | 6.32 | 80 | 60 | 29.5 | Not bended |
| EX 2-26 | U | Silicon compound | 1.0 | | | 1.0 | 980 | | 890 | 7.46 | 95 | 120 | 36.5 | Not bended |
| EX 2-27 | L | — | 0.5 | | | 0.5 | 1176 | | 910 | 7.56 | 96 | 129 | 28.4 | Not bended |
| EX 2-28 | L | — | 1.0 | | | 0.2 | 1470 | | 780 | 7.72 | 98 | 143 | 27.5 | Not bended |
| EX 2-29 | V | Silicon compound | 1.0 | | | 0.2 | 1470 | | 3980 | 7.70 | 98 | 140 | 27.3 | Not bended |
| EX 2-30 | W | Silicon compound | 0.5 | | | 0.2 | 1470 | | 3520 | 7.71 | 98 | 139 | 28.1 | Not bended |
| EX 2-31 | X | Silicon compound | 0.1 | | | 0.2 | 1470 | | 2980 | 7.69 | 98 | 137 | 28.0 | Not bended |
| EX 2-32 | Y | Silicon compound | 0.5 | | | 0.2 | 1470 | | 200 | 7.67 | 98 | 135 | 38.7 | Not bended |
| EX 2-33 | R | Silicon compound | 0.5 | | | 0.05 | 1960 | | 125 | 7.79 | 99 | 150 | 47.9 | Not bended |
| EX 2-34 | S | Silicon compound | 2.0 | | | 2.0 | 686 | | 11980 | 6.85 | 87 | 74 | 31.5 | Not bended |
| EX 2-35 | U | Silicon compound | 1.0 | | | 0.2 | 1470 | | 3860 | 7.71 | 98 | 140 | 27.0 | Not bended |
| EX 2-36 | Z | Phosphate compound 1 | 0.1 | | | 0.2 | 1470 | | 1970 | 7.70 | 98 | 140 | 29.4 | Not bended |
| EX 2-37 | Z1 | Phosphate compound 2 | 0.1 | | | 0.2 | 1470 | | 1210 | 7.68 | 98 | 135 | 31.8 | Not bended |
| EX 2-38 | Z2 | Phosphate compound 3 | 0.1 | | | 0.2 | 1470 | | 1190 | 7.67 | 98 | 135 | 32.4 | Not bended |

*no pigment
**refer to Table 4-1 and 4-2
EX: EX: Example
CE: Comparative Example

In each Example, a powder core having a high resistivity, improved insulation property, and reduced core loss is produced. Each of Examples 2-1 to 2-10 shows improved insulation property compared to that in the case where only the coating containing silicone resin and pigment was formed on the surface (Example 1-23). Furthermore, the insulation property is excellent and the core loss is reduced compared to comparative examples 2-1 and 2-2 in which a coating containing silicone resin and pigment was not formed on the surface. Example 2-11, in which a rolling fluidized granulator was used for mixing during formation of the lower layer coating, shows an improved insulation property and reduced core loss compared to those of Example 2-7, in which a Henschel mixer was used.

In Examples 2-12, 2-27, and 2-28, phosphoric acid or a silicon compound was added to a paint, and mixing was performed so as to prepare a paint capable of performing a lower layer coating treatment and upper layer coating treatment by the same process, the resulting paint was added to a powder primarily containing iron, and mixing was performed so as to form a coating containing silicone resin, pigment, and furthermore compound on the surface of the iron-based powder. Each of Examples 2-12, 2-27, and 2-28, in which the aforementioned iron-based powder was used, shows an improved insulation property and reduced core loss compared to those of Example 1-23, in which a coating containing only silicone resin and pigment is included. The compound was added to the paint in order that the content of phosphoric acid or a silicon compound in the coating became the amount shown in Table 5-1 and 5-2 relative to the total iron-based powder.

### Example 3

An iron powder “KIP(R)-304A” manufactured by Kawasaki Steel Corporation shown in Table 1 (Powder No.=b) as the raw material powder primarily containing iron was classified by a sieve with mesh #100 or #200. “KIP(R)-304A+#100” (Raw material powder No.=e) which is a plus sieve (mesh #100) powder and “KIP(R)-304A -#200” (Raw material powder No.=f) which is a minus sieve (mesh #200) powder were subjected beforehand to a surface treatment for forming a coating containing a compound shown in Table 7 as the lower layer coating, and were made to be raw material powders (Raw material powder No.=GA, GB, GC, GD, GE, and GF) for the succeeding step. The surface treatment for forming the lower layer coating was performed by the steps of adding a solution containing respective compounds shown in Table 7 to the raw material powders (No.=e and f), agitating and mixing, standing for 24 hours in a draft, and drying. The concentration of the compound in the solution was specified to be 5% by mass. Regarding addition of the compound to the raw material powder, the solution containing the compound was added to the raw material powder in order that the addition amount of the compound to the raw material powder became the value shown in Table 7. The whole solution containing the compound was added to the powder primarily containing iron and, thereafter, agitation and mixing were performed using a Henschel mixer so as to produce the raw material powder in which the lower layer coating was formed. The mixing time was specified to be 400 seconds.

In a manner similar to that in Example 1, a paint, in which a silicone resin and pigment were added to a solvent in order that the content thereof became as shown in Table 8, was added to the aforementioned raw material powder (No.=e, f, GA, GB, GC, GD, GE, and GF), and agitation and mixing were performed using a Henschel mixer. The resulting powder was subjected to a drying treatment. Regarding the drying treatment, after agitation and mixing, standing was performed at room temperature for 10 hours, and heating and drying were performed at 250° C. for 120 minutes. According to this treatment, an iron-based powder in which a coating (upper layer coating) containing silicone resin and pigment was formed on the powder surface or lower layer coating, was produced.

A lubricant was added to the iron-based powder including the coating on the surface produced as described above, and mixing was performed. Zinc stearate was used as the lubricant. The addition amount of the lubricant was specified to be 0.25 parts by weight relative to 100 parts by weight of the iron-based powder.

Addition and mixing of the lubricant was performed in a manner similar to that in Example 2.

The resulting powder mixture was pressed at a pressure shown in Table 9 and, therefore, compacts of a ring test piece (outer diameter of 38 mm, inner diameter of 25 mm, and height of 6.2 mm) for magnetic measurement and a rectangular parallelepiped test piece (width of 10 mm, length of 35 mm, and height of 6.2 mm) for resistivity measurement were produced.

The resulting compacts were subjected to annealing at 800° C. for 1 hour in nitrogen atmosphere.

Regarding these compacts (powder core) after annealing, similarly to Example 1, the powder core density, resistivity, inductance at 10 kHz, and core loss at 10 kHz and 0.1 T were measured. Furthermore, a manual bending test was performed. The measuring method and the testing method were similar to those in Example 1.

Furthermore, regarding the compacts (powder core) after annealing, the core loss at 1 kHz and 0.1 T and the magnetic flux density B₁₀₀₀₀ at an applied magnetic field H=10000 A/m, or the core loss at 5 kHz and 0.2 T were measured using the ring test pieces. The core loss was measured with a B-H Analyzer (E5060A) manufactured by Agilent Technologies using a coil made from 40 turns at each of primary side and secondary side of formal covered wire 0.6 mm in diameter wound on the ring test piece. The magnetic flux density was measured with a Magnetic hysteresis loop tracer 3257 type manufactured by Yokogawa Electric Corporation using a coil made from 100 turns at primary side and 20 turns at secondary side of formal covered wire 0.6 mm in diameter wound on the ring test piece. Likewise, measurements were performed regarding the test piece of Example 1-23, which was the compact (powder core) after annealing, produced in Example 1. The results thereof are shown in Table 9.

TABLE 7

| | Raw material powder | Mixing method | | Solution | |
|---|---|---|---|---|---|
| Raw material | No. primarily | Apparatus | Time | Sort of compound | |
| powder No. | containing iron | used | (s) | (% by mass) | Solvent |
| GA | (e) KIP-304A #100** | Henschel | 400 | Phosphoric acid: | Ethanol |
| | | mixer | | 0.05 | |
| GB | (f) KIP-304A #200** | | | | |

| | | | |
|---|---|---|---|
| GC | (e) KIP-304A #100** | Rolling fluidized | Methyltrimethoxy- |
| | | granulator | silane: 0.3 |
| GD | (e) KIP-304A #100** | | Methyltrimethoxy- |
| | | | silane: 0.5 |
| GE | (e) KIP-304A #100** | | Methyltrimethoxy- |
| | | | silane: 1.0 |
| GF | (f) KIP-304A #200** | | Methyltrimethoxy- |
| | | | silane: 1.0 |

*relative to the total powder primarily containing iron
**refer to Table 1

TABLE 8

| | | Paint | | | | | | | | | |
|---|---|---|---|---|---|---|---|---|---|---|---|
| | Raw | | | Pigment | | | | | | | |
| | material | Silicone resin | | | Organic | | | Iron | Chromium | Copper | Total |
| Category | powder | Sort | Content | Alumina | bentonite | Talc | Titania | oxide | oxide | oxide | content |
| EX 3-1 | e | SR2410 | 40 | 36 | 2 | 8 | 8 | 2 | 2 | 2 | 60 |
| EX 3-2 | GA | SR2410 | 40 | 36 | 2 | 8 | 8 | 2 | 2 | 2 | 60 |
| EX 3-3 | e | SR2410 | 20 | 40 | | 40 | | | | | 80 |
| EX 3-4 | GA | SR2410 | 20 | 40 | | 40 | | | | | 80 |
| EX 3-5 | f | SR2410 | 20 | 40 | | 40 | | | | | 80 |
| EX 3-6 | e | SR2410 | 40 | 36 | 2 | 8 | 8 | 2 | 2 | 2 | 60 |
| EX 3-7 | GC | SR2410 | 40 | 36 | 2 | 8 | 8 | 2 | 2 | 2 | 60 |
| EX 3-8 | e | SR2410 | 20 | 40 | | 40 | | | | | 80 |
| EX 3-9 | GD | SR2410 | 20 | 40 | | 40 | | | | | 80 |
| EX 3-10 | GE | SR2410 | 20 | 40 | | 40 | | | | | 80 |
| EX 3-11 | f | SR2410 | 40 | 36 | 2 | 8 | 8 | 2 | 2 | 2 | 60 |
| EX 3-12 | GB | SR2410 | 40 | 36 | 2 | 8 | 8 | 2 | 2 | 2 | 60 |
| EX 3-13 | f | SR2410 | 20 | 40 | | 40 | | | | | 80 |
| EX 3-14 | GB | SR2410 | 20 | 40 | | 40 | | | | | 80 |
| EX 3-15 | GF | SR2410 | 20 | 40 | | 40 | | | | | 80 |
| EX 3-16 | GF | SR2410 | 20 | 40 | | 40 | | | | | 80 |
| EX 1-23 | b | SR2410 | 40 | 36 | 2 | 8 | 8 | 2 | 2 | 2 | 60 |

TABLE 9

| | |
|---|---|
| Iron-based powder | |
| Coating | Powder core |

| | Lower layer | | Upper layer | | | | | | Test results | | | | | | | | |
|---|---|---|---|---|---|---|---|---|---|---|---|---|---|---|---|---|---|
| | | Adhesion | | | Silicone | Adhesion | | | | | Value | AC relative | | | | Magnetic | |
| | | amount | Mixing Method | | resin/ | amount | Pressing | | Resis- | | relative to | initial | Core loss | Core loss | Core loss | flux den- | Manual |
| | Sort of | (% by | Apparatus | Time | Pigment | (% by | pressure | | tivity | Density | true den- | permeability | (10 kHz, 0.1 | (1 kHz, 0.1 | (5 kHz, 0.2 | sity B10- | bending |
| Category | coating | mass) | used | (s) | ratio R | mass) | (MPa) | Annealing | (μΩm) | (Mg/m³) | sity (%) | (μ_{IAC}) | T) (W/kg) | T) (W/kg) | T) (W/kg) | 000 (T) | test |
| EX 3-1 | — | — | Henschel | 400 | 0.67 | 0.5 | 1176 | Performed | 104 | 7.67 | 98 | 110 | 45.2 | 2.30 | — | 1.65 | Not bended |
| | | | mixer | | | | | | | | | | | | | | |
| EX 3-2 | Phosphorus | 0.05 | | | | | | | 180 | 7.65 | 97 | 129 | 32.5 | 2.29 | — | 1.58 | Not bended |
| | compound | | | | | | | | | | | | | | | | |
| EX 3-3 | — | — | | | 0.25 | | | | 150 | 7.67 | 98 | 137 | 42.1 | 2.12 | — | 1.67 | Not bended |
| EX 3-4 | Phosphorus | 0.05 | | | | | | | 232 | 7.66 | 97 | 143 | 34.3 | 2.01 | — | 1.65 | Not bended |
| | compound | | | | | | | | | | | | | | | | |
| EX 3-5 | — | — | | | | | 1470 | | 430 | 7.67 | 98 | 136 | 24.1 | 1.76 | — | 1.68 | Not bended |
| EX 3-6 | — | — | | | 0.67 | 0.5 | 686 | Performed | 340 | 7.28 | 93 | 78 | 34.3 | 2.50 | — | 1.37 | Not bended |
| EX 3-7 | Silicon | 0.3 | | | | | | | 678 | 7.26 | 92 | 77 | 34.5 | 2.60 | — | 1.35 | Not bended |
| | compound | | | | | | | | | | | | | | | | |
| EX 3-8 | — | — | | | 0.25 | | 980 | | 210 | 7.53 | 96 | 119 | 33.4 | 2.20 | — | 1.46 | Not bended |
| EX 3-9 | Silicon | 0.5 | | | | | | | 312 | 7.52 | 96 | 117 | 33.0 | 2.18 | — | 1.43 | Not bended |
| | compound | | | | | | | | | | | | | | | | |
| EX 3-10 | Silicon | 1.0 | | | | 0.2 | 1470 | | 460 | 7.70 | 98 | 150 | 31.2 | 1.98 | — | 1.72 | Not bended |
| | compound | | | | | | | | | | | | | | | | |
| EX 3-11 | — | — | | | 0.67 | 0.5 | 1176 | | 450 | 7.54 | 96 | 93 | 28.1 | — | 53 | — | Not bended |
| EX 3-12 | Phosphorus | 0.05 | | | | | | | 1020 | 7.53 | 96 | 99 | 23.2 | — | 42 | — | Not bended |
| | compound | | | | | | | | | | | | | | | | |
| EX 3-13 | — | — | | | 0.25 | | | | 570 | 7.55 | 96 | 96 | 27.4 | — | 35 | — | Not bended |
| EX 3-14 | Phosphorus | 0.05 | | | | | | | 1402 | 7.54 | 96 | 102 | 21.2 | — | 33 | — | Not bended |
| | compound | | | | | | | | | | | | | | | | |
| EX 3-15 | Silicon | 1.0 | | | | | 686 | | 3980 | 7.12 | 91 | 72 | 30.1 | — | 37 | — | Not bended |
| | compound | | | | | | | | | | | | | | | | |
| EX 3-16 | Silicon | 1.0 | | | | | 1470 | | 1201 | 7.68 | 98 | 135 | 23.1 | — | 34 | — | Not bended |
| | compound | | | | | | | | | | | | | | | | |
| EX 1-23 | — | — | | | 0.67 | 0.5 | 1176 | | 275 | 7.59 | 97 | 117 | 32.5 | 2.40 | 65 | 1.50 | Not bended |

Each of Examples 3-l and 3-2, in which a raw material powder (powder primarily containing iron) having a particle diameter larger than that in Example 1-23 was used, shows a reduced core loss at 1 kHz and 0.1 T and increased magnetic flux density B₁₀₀₀ by 0.1 T or more compared to those of Example 1-23. Example 3-5, in which the raw material powder was-#200, and pressing was performed at 1,176 MPa, shows a high compact density even though the powder having a fine particle diameter was used, and the magnetic flux density B₁₀₀₀₀ is also high. On the other hand, the core loss at 10 kHz and 0.1 T is lower than that of the powder having a large particle diameter. Therefore, it is clear that when fine raw material powder is used and pressing is performed at a high pressure, a high magnetic flux density and a low core loss can be compatible. Each of Examples 3-11 to 3-14, in which a raw material powder having a particle diameter smaller than that in Example 1-23 was used, shows a reduced core loss at 5 kHz and 0.2 T and a reduced core loss at 10 kHz and 0.1 T.

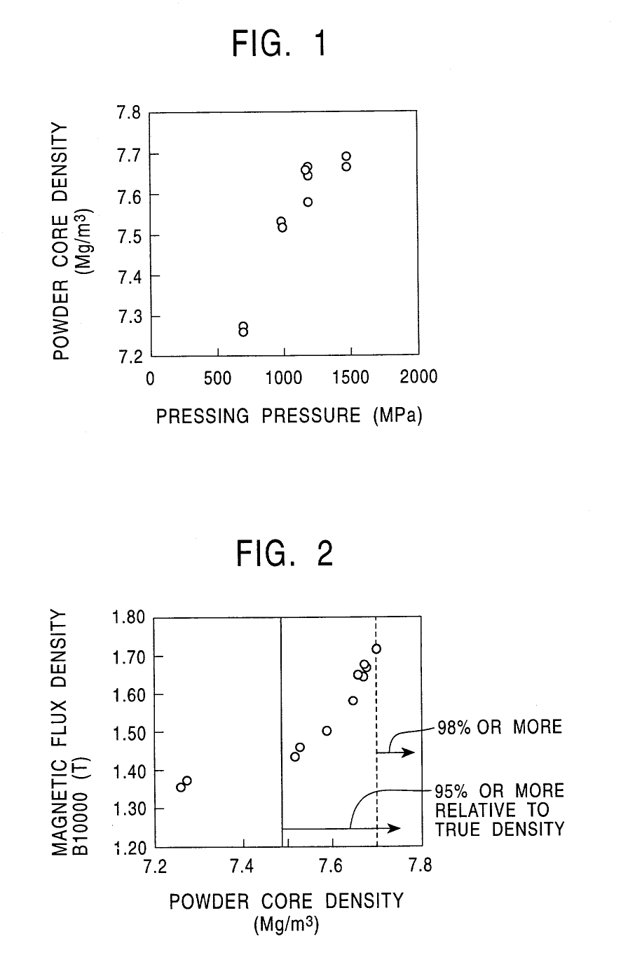

FIG. 1 is a diagram showing the relationship between the pressing pressure and the powder core density. The powder core density increases with increases in pressing pressure, and regarding the iron-based powder shown in this example, when the pressing pressure is 980 MPa or more, a powder core having a density of 95% or more relative to the true density is produced. FIG. 2 is a diagram showing the relationship between the powder core density and the magnetic flux density. Increases in the magnetic flux density are observed as the powder core density increases. Furthermore, when the powder core density is 7.47 Mg/m³ or more, the degree of improvement of the magnetic flux density becomes remarkably large relative to the increase in the powder core density. Since when the powder core density shows the value of 95% or more relative to the true density, the magnetic characteristics, for example, a magnetic flux density, are improved remarkably, it is clear that the powder core density is preferably specified to be 95% or more of the true density.

Furthermore, when the powder core density becomes 7.70 Mg/m³ or more, this corresponds to 98% or more relative to the true density, the magnetic flux density B₁₀₀₀₀ becomes 1.70 T or more and, therefore, the magnetic flux density equivalent to that in the case where an electrical steel plate is used is realized. This indicates that the present invention can be applied to the uses in which high torque output is required, such as motors.

### Example 4

In Examples 4-1 to 4-5, two sorts of paints shown in Table 10 were prepared, each paint was added using an apparatus shown in Table 11-1 so that the adhesion amount became as shown in the same Table 11-1 and, therefore, the coating of the paint containing silicone resin and pigment was formed on the surface of the raw material powder. The raw material powder used at that time is also shown in Table 11-1.

When the paint was added to the raw material powder primarily containing iron, formation of the first coating was performed in a manner similar to that shown in Example 1, drying was performed, and thereafter, formation of the second coating was performed in a manner similar to that shown in the same Example 1. Subsequently, the resulting powder was dried and, therefore, the targeted iron-based powder was produced.

In Example 4-5, a surface treatment was performed with phosphoric acid, and a powder including a lower layer coating containing phosphorus compound was used as the raw material powder primarily containing iron. The surface treatment for forming the lower layer coating was performed in a manner similar to that in Example 2. The paint shown in Table 10 was added to this raw material powder according to the instructions shown in Table 11-1 in a manner similar to that described above so as to form the coating and, therefore, the targeted iron-based powder was produced.

Test pieces similar to those in Example 1 were prepared using the aforementioned iron-based powders, and evaluation similar to that in Example 1 was performed. The results thereof are shown in Table 11-2.

It is clear that the present invention is effective in the case where a plurality of paints are sequentially applied by coating.

TABLE 10

| | Paint | | | | | | | | | |
|---|---|---|---|---|---|---|---|---|---|---|
| | Silicone resin | | Pigment | | | | | | | |
| | | | | Organic | | | Iron | Chromium | Copper | Total |
| | Sort | Content | Alumina | bentonite | Talc | Titania | oxide | oxide | oxide | content |
| Paint for the | SR2410 | 20 | 40 | | 40 | | | | | 80 |
| first coating | | | | | | | | | | |
| Paint for the | SR2410 | 40 | 36 | 2 | 8 | 8 | 2 | 2 | 2 | 60 |
| second coating | | | | | | | | | | |

TABLE 11-1

| | Iron-based powder | | | | | | | | | | | |
|---|---|---|---|---|---|---|---|---|---|---|---|---|
| | | | | Upper layer | | | | | | | | |
| | | | | Upper layer (the first coating) | | | | Upper layer (the second coating) | | | | |
| | | Lower layer | | | | Coating | | | | Coating | | |
| | Raw | | Adhesion | Mixing method | | Silicone | Adhesion | Mixing method | | Silicone | Adhesion | Total coating |
| Cate- | material | Sort of | amount | Apparatus | Time | resin/ | amount | Apparatus | Time | resin/ | amount | amount |
| gory | powder | coating | (% by mass) | used | (s) | Pigment R | (% by mass) | used | (s) | Pigment R | (% by mass) | (% by mass) |
| EX 4-1 | b | — | — | Henschel | 400 | 0.25 | 0.25 | Henschel | 400 | 0.67 | 0.25 | 0.5 |
| | | | | mixer | | | | mixer | | | | |
| EX 4-2 | b | — | — | | | | 0.1 | | | | 0.4 | |

| EX 4-3 | b | — | — | Rolling fluidized | 0.25 | Rolling fluidized | | 0.25 |
|---|---|---|---|---|---|---|---|---|
| | | | | granulator | | granulator | | |
| EX 4-4 | e | — | — | | 0.4 | Henschel | 400 | 0.1 |
| | | | | | | mixer | | |
| EX 4-5 | b | Phos- | 0.05 | | 0.4 | | | 0.1 |
| | | phorus | | | | | | |
| | | compound | | | | | | |

TABLE 11-2

| | Powder core | | | | | | | |
|---|---|---|---|---|---|---|---|---|
| | | | Test results | | | | | |
| | Pressing | | | | Value rela- | AC relative | Core loss | Manual |
| | pressure | | Resistivity | Density | tive to true | initial permea- | (10 kHz, 0.1 | bending |
| Category | (MPa) | Annealing | (μΩm) | (Mg/m³) | density (%) | bility (μ_{IAC}) | T) (W/kg) | test |
| EX 4-1 | 686 | Performed | 230 | 7.21 | 92 | 94 | 38.5 | Not bended |
| EX 4-2 | | | 190 | 7.09 | 90 | 92 | 41.2 | Not bended |
| EX 4-3 | | | 395 | 7.24 | 92 | 95 | 36.2 | Not bended |
| EX 4-4 | | | 210 | 7.27 | 92 | 92 | 39.4 | Not bended |
| EX 4-5 | | | 1345 | 7.25 | 92 | 98 | 28.1 | Not bended |

### Example 5

In Examples 5-1 to 5-7, powder core test pieces were produced from an iron-based powder produced in a manner similar to those in Example 1 and Example 2. The producing conditions were as shown in Table 12. Herein, pressing was performed at a pressing pressure of 1,470 MPa, and the condition of subsequent annealing was changed as shown in Table 12. Methyltrimethoxysilane was used as the silicon compound for the lower layer coating. As the paint for the upper layer coating, the same paint as that in Example 1-47 was used (refer to Table 2-3). Regarding these test pieces, characteristics were evaluated in a manner similar to those in Example 1. The results thereof are shown in Table 12. The core loss is reduced with increases in annealing temperature, and especially, when the annealing temperature is raised to 400° C. or more, remarkable reduction of core loss is observed. The initial permeability is increased as the annealing temperature is increased. Consequently, it is clear that the magnetic characteristics of the powder core produced according to the present invention are improved by annealing, and in particular, remarkable effect of improving magnetic characteristics can be achieved by annealing at a temperature of 400° C. or more.

TABLE 12

| | Iron-based powder | | | | | | | | | | | | | |
|---|---|---|---|---|---|---|---|---|---|---|---|---|---|---|
| | | Coating | | | | | Powder core | | | | | | | |
| | | | | Upper layer | | | | | | | | | | |
| | | Lower layer | | Mixing | Silicone | | | | Test results | | | | | |
| | Raw | | Adhesion | method | resin/ | Adhesion | Pressing | Annealing | Resisti- | Density | Value rela- | AC relative | Core loss | Manual |
| | material | Sort of | amount | Apparatus | Pigment | amount | pressure | tempera- | vity | (Mg/ | tive to true | initital permea- | (10 kHz, 0.1 | bending |
| Category | powder | coating | (% by mass) | used | ratio R | (% by mass) | (MPa) | ture (° C.) | (μΩm) | m³) | density (%) | bility (μ_{IAC}) | T) (W/kg) | test |
| EX 5-1 | b | — | — | Rolling | 0.25 | 0.5 | 1470 | Not | 1560 | 7.66 | 97 | 91 | 56.0 | Not |
| | | | | fluidized | | | | annealed | | | | | | bended |
| | | | | granulator | | | | | | | | | | |
| EX 5-2 | b | — | — | | | | | 400 | 890 | 7.66 | 97 | 102 | 42.4 | Not |
| | | | | | | | | | | | | | | bended |
| EX 5-3 | b | — | — | | | | | 500 | 250 | 7.67 | 98 | 118 | 42.0 | Not |
| | | | | | | | | | | | | | | bended |
| EX 5-4 | b | — | — | | | | | 700 | 140 | 7.68 | 98 | 123 | 39.8 | Not |
| | | | | | | | | | | | | | | bended |
| EX 5-5 | b | Silicon | 1.0 | | | | | Not | 12200 | 7.65 | 97 | 86 | 55.3 | Not |
| | | compound | | | | | | annealed | | | | | | bended |
| EX 5-6 | b | Silicon | 1.0 | | | | | 500 | 2300 | 7.65 | 97 | 115 | 37.0 | Not |
| | | compound | | | | | | | | | | | | bended |
| EX 5-7 | b | Silicon | 1.0 | | | | | 700 | 1430 | 7.66 | 97 | 124 | 32.0 | Not |
| | | compound | | | | | | | | | | | | bended |

### Example 6

In Examples 6-1 to 6-8, powder core test pieces were produced from an iron-based powder produced in a manner similar to those in Example 1 and Example 2. The producing conditions were as shown in Table 13. Herein, pressing was performed at 686 MPa and, thereafter, cold core forging was performed so as to control the density to be as shown in Table 13. Annealing was performed at a temperature shown in Table 13. Methyltrimethoxysilane was used as the silicon compound for the lower layer coating. As the paint for the upper layer coating, the same paint as that in Example 1-47 was used (refer to Table 2-2). Regarding these test pieces, characteristics were evaluated in a manner similar to those in Example 1. The results thereof are shown in Table 13. It is clear that the powder core according to the present invention exhibits superior magnetic characteristics similar to those in the case where common pressing is performed even when the powder core is produced by cold forging.

TABLE 13

| | Iron-based powder | | | | | | | | | | | | | |
|---|---|---|---|---|---|---|---|---|---|---|---|---|---|---|
| | | Coating | | | | | Powder core | | | | | | | |
| | | | | Upper layer | | | | | | | | | | |
| | | Lower layer | | Mixing | Silicone | | | | | Test results | | | | |
| | Raw | | Adhesion | method | resin/ | Adhesion | Density | Value rela- | Annealing | Resisti- | AC relative | Core loss | Magnetic | Manual |
| | material | Sort of | amount | Apparatus | Pigment | amount | (Mg/ | tive to true | tempera- | -vity | initital permea- | (10 kHz, 0.1 | flux density | bending |
| Category | powder | coating | (% by mass) | used | ratio R | (% by mass) | m³) | density (%) | ture (° C.) | (μΩm) | bility (μ_{IAC}) | T) (W/kg) | B10000 (T) | test |
| EX 6-1 | b | — | — | Rolling | 0.25 | 0.5 | 7.70 | 98 | 500 | 190 | 135 | 42.0 | 1.69 | Not bended |
| | | | | fluidized | | | | | | | | | | |
| | | | | granulator | | | | | | | | | | |
| EX 6-2 | b | — | — | | | 0.5 | 7.70 | 98 | 700 | 150 | 140 | 38.4 | 1.71 | Not bended |
| EX 6-3 | b | — | — | | | 0.2 | 7.75 | 99 | 500 | 140 | 140 | 45.0 | 1.72 | Not bended |
| EX 6-4 | b | — | — | | | 0.2 | 7.75 | 99 | 700 | 80 | 145 | 36.4 | 1.75 | Not bended |
| EX 6-5 | b | — | — | | | 0.2 | 7.75 | 99 | 800 | 40 | 154 | 37.1 | 1.78 | Not bended |
| EX 6-5 | b | Silicon | 1.0 | | | 0.5 | 7.70 | 98 | 500 | 890 | 129 | 37.0 | 1.67 | Not bended |
| | | compound | | | | | | | | | | | | |
| EX 6-7 | b | Silicon | 1.0 | | | 0.2 | 7.75 | 99 | 500 | 790 | 140 | 38.3 | 1.71 | Not bended |
| | | compound | | | | | | | | | | | | |
| EX 6-8 | b | Silicon | 1.0 | | | 0.2 | 7.75 | 99 | 800 | 450 | 155 | 32.1 | 1.75 | Not bended |
| | | compound | | | | | | | | | | | | |

### Example 7

In Example 7, an iron-based powder was produced in a manner similar to those in Example 1 and Example 2. Subsequently, powder core test pieces were produced under the conditions shown in Table 14-1. Pressing temperatures and lubricating conditions are shown in Table 14-1. After pressing, annealing was performed at a temperature shown in Table 14-2. Methyltrimethoxysilane or hydrolized ethyl silicate were used as the silicon compound for the lower layer coating. Paint used for the upper layer coating are shown in Table 15. Regarding a warm pressing method or warm die lubrication pressing method in which pressing was performed at a pressing temperature of 130° C., a die for pressing was pre-heated, so that the die surface temperature was made to be at the pressing temperature. The iron-based powder heated to the same temperature as the pressing temperature was put into the die and, thereafter, pressing was performed. When die lubrication is performed, a so-called fluid die lubrication method, in which the concentration of a lubricant in an ethanol solvent was adjusted to be 5% by mass so as to prepare a lubricant solution, the resulting lubricant solution was applied by coating, and after the solvent was dried, pressing was performed, and a so-called powder die lubrication method, in which a lubricant electricaly charged in a lubrication apparatus was introduced in a die by spraying using a die lubrication apparatus (manufactured by Gasbarre Products, Inc.), and the lubricant was adhered on the die surface due to charge, were used. The adhesion amount of the labricant to the die was specified to be 10 g/m² in each method. Regarding these test pieces, characteristics were evaluated in a manner similar to those in Example 1. The results thereof are shown in Table 14-2. It is clear that the powder core according to the present invention exhibits superior magnetic characteristics similar to those in the case where common pressing is performed even when the powder core is produced using a so-called warm pressing, die lubrication pressing, or warm die lubrication pressing.

TABLE 14-1

| | | Lower layer | | Upper layer | | | |
|---|---|---|---|---|---|---|---|
| | | | Adhesion | | Mixing method | Silicone | Adhesion |
| | | | amount | Paint | Apparatus | resin/Pigment | amount |
| Category | Raw material powder | Sort of coating | (% by mass) | Category | used | ratioR | (% by mass) |
| EX 7-1 | b | — | 0.0 | A | Rolling | 0.25 | 0.50 |
| EX 7-2 | | | | | fluidized | | |
| EX 7-3 | | | | | granulator | | |
| EX 7-4 | | | | | | | |
| EX 7-5 | | | | | | | |
| EX 7-6 | | | | | | | |
| EX 7-7 | | | | | | | |
| EX 7-8 | | | | | | | |
| EX 7-9 | | | | | | | |
| EX 7-10 | | Methyltrimet- | 1.0 | | | | |
| EX 7-11 | | hoxysilane | | | | | |
| EX 7-12 | | | | | | | |
| EX 7-13 | | | | | | | |
| EX 7-14 | | | | | | | |
| EX 7-15 | | | | | | | |
| EX 7-16 | | | | | | | |
| EX 7-17 | | ethyl silicate after | | | | | |
| EX 7-18 | | hydrolusis | | | | | |
| EX 7-19 | | Methyltrimet- | | B | | | |
| EX 7-20 | | hoxysilane | | | | | |

| | Powder core | | | | |
|---|---|---|---|---|---|
| | Pressing condition | | | | |
| | Pressing | Pressing | | | |
| | temperature | pressure | | | Melting point of |
| Category | (° C.) | (MPa) | Lubricating method | Lubricant used | the lubricant |
| EX 7-1 | 25 | 980 | Fluid die lubrication method | Zinc stearate | 127 |
| EX 7-2 | | | Powder die lubricant method | Zinc stearate | 127 |
| EX 7-3 | 130 | | Blended into iron-based powder (*1) | Lithium stearate | 230 |
| EX 7-4 | | | Fluid die lubrication method | Lithium stearate | 230 |
| EX 7-5 | | | Powder die lubrication method | Lithium stearate | 230 |
| EX 7-6 | | | Powder die lubrication method | Mixture lubricant (*2) | 127 to 230 (*3) |
| EX 7-7 | 25 | 1470 | Fluid die lubrication method | Zinc stearate | 127 |
| EX 7-8 | 130 | | Blended into iron-based powder | Lithium stearate | 230 |
| EX 7-9 | | | Powder die lubrication method | Lithium stearate | 230 |
| EX 7-10 | 25 | 980 | Fluid die lubrication method | Zinc stearate | 127 |
| EX 7-11 | 130 | | Blended into iron-based powder (*1) | Lithium stearate | 230 |
| EX 7-12 | | | Powder die lubrication method | Lithium stearate | 230 |
| EX 7-13 | | | Powder die lubrication method | Mixture lubricant (*2) | 127 to 230 (*3) |
| EX 7-14 | 25 | 1470 | Fluid die lubrication method | Zinc stearate | 127 |
| EX 7-15 | | | Fluid die lubrication method | Zinc stearate | 127 |
| EX 7-16 | 130 | | Powder die lubrication method | Mixture lubricant (*2) | 127 to 230 (*3) |
| EX 7-17 | 130 | 1470 | Powder die lubrication method | Lithium stearate | 230 |
| EX 7-18 | 130 | 1470 | Powder die lubrication method | Lithium stearate | 230 |
| EX 7-19 | 130 | 1470 | Fluid die lubrication method | Lithium stearate | 230 |
| EX 7-20 | 130 | 1470 | Powder die lubrication method | Lithium stearate | 230 |

(*1) 0.25 parts by weight was blended in a manner similar to that in Example 1
(*2) lithium stearate and zinc stearate were mixed at a weight ratio of 1:1
(*3) zinc stearate lubricates at 127° C. and lithium stearate lubricates at 230° C.
EX: Example

TABLE 14-2

| | Powder core | | | | | | |
|---|---|---|---|---|---|---|---|
| | | Test results | | | | | |
| | Annealing | Resistivity | Density | Value relative to | AC relative | Core loss | |
| Category | temperature (° C.) | (μΩm) | (Mg/m³) | true density (%) | initial permeability | (10 kHz, 0.1 T) (W/kg) | Manual bending test |
| EX 7-1 | 700 | 200 | 7.62 | 97 | 123 | 38.8 | Not bended |
| EX 7-2 | 700 | 190 | 7.62 | 97 | 134 | 39.1 | Not bended |
| EX 7-3 | 700 | 18 | 7.63 | 97 | 135 | 39.5 | Not bended |
| EX 7-4 | 700 | 190 | 7.64 | 97 | 136 | 39.8 | Not bended |
| EX 7-5 | 700 | 185 | 7.64 | 97 | 136 | 38.5 | Not bended |
| EX 7-6 | 700 | 197 | 7.65 | 98 | 136 | 39.0 | Not bended |
| EX 7-7 | 700 | 135 | 7.69 | 98 | 135 | 40.1 | Not bended |
| EX 7-8 | 700 | 1120 | 7.70 | 98 | 139 | 40.8 | Not bended |
| EX 7-9 | 700 | 125 | 7.72 | 98 | 140 | 41.0 | Not bended |
| EX 7-10 | 700 | 2400 | 7.62 | 97 | 141 | 31.8 | Not bended |
| EX 7-11 | 700 | 2340 | 7.63 | 97 | 134 | 30.9 | Not bended |
| EX 7-12 | 700 | 2400 | 7.64 | 97 | 135 | 31.0 | Not bended |
| EX 7-13 | 700 | 2450 | 7.65 | 98 | 134 | 32.0 | Not bended |
| EX 7-14 | 400 | 2500 | 7.66 | 98 | 137 | 37.0 | Not bended |
| EX 7-15 | 700 | 1400 | 7.67 | 98 | 136 | 31.0 | Not bended |
| EX 7-16 | 700 | 1450 | 7.70 | 98 | 140 | 30.0 | Not bended |
| EX 7-17 | 700 | 1570 | 7.71 | 98 | 140 | 28.4 | Not bended |
| EX 7-18 | 800 | 1450 | 7.72 | 98 | 150 | 26.4 | Not bended |
| EX 7-19 | 800 | 1500 | 7.71 | 98 | 141 | 28.9 | Not bended |
| EX 7-20 | 800 | 1490 | 7.72 | 98 | 148 | 30.2 | Not bended |

EX: Example

TABLE 15
Paitnt*

| | Silicone | | | | | |
|---|---|---|---|---|---|---|
| | Resin | | Pigment | | | |
| | | Con- | | | Total | Silicon resin/ |
| Category | Sort | tent | Alumina | Talc | Content | Pigment ratio R |
| A | SR2410 | 20 | 40 | 40 | 80 | 0.25 |
| B | SH805 | 20 | 40 | 40 | 80 | 0.25 |

*A content is a value relation to the total of silicone resin and pigment (% by mass).
Xylen is used as solvent for paint.
A concentration of the paint is specified to be 20% by mass.

What is claimed is:

1. A ferromagnetic-metal-based powder containing a ferromagnetic metal powder, wherein the surface of the ferromagnetic metal powder is coated with a coating containing silicone resin and pigment.

2. The ferromagnetic-metal-based powder according to claim 1, wherein the ferromagnetic metal powder is a powder primarily comprising iron, and the ferromagnetic-metal-based powder is an iron-based powder.

3. The ferromagnetic-metal-based powder according to claim 2, wherein the powder primarily comprising iron is a pure iron powder.

4. The ferromagnetic-metal-based powder according to claim 1 or claim 2, comprising a coating containing at least one material selected from the group consisting of silicon compounds, titanium compounds, zirconium compounds, phosphorus compounds, and chromium compounds as a substrate layer of the coating containing silicone resin and pigment.

5. The ferromagnetic-metal-based powder according to claim 1 or claim 2, wherein the pigment is at least one selected from the group consisting of metal oxides, metal nitrides, metal carbides, minerals, and glass.

6. The ferromagnetic-metal-based powder according to claim 1 or claim 2, wherein the ratio of the silicone resin content to the pigment content in the coating containing silicone resin and pigment is 0.01 or more, but less than 4.0 on a mass basis.

7. The ferromagnetic-metal-based powder according to claim 1 or claim 2, wherein the adhesion amount of the coating containing silicone resin and pigment is 0.01% to 25% by mass relative to the total amount of the ferromagnetic-metal-based powder.

8. A powder core made by pressing the ferromagnetic-metal-based powder according to claim 1 or claim 2.

9. A powder core made by pressing the ferromagnetic-metal-based powder according to claim 4.

10. A powder core made by pressing and, thereafter, annealing the ferromagnetic-metal-based powder according to claim 1 or claim 2.

11. A powder core made by pressing and, thereafter, annealing the ferromagnetic-metal-based powder according to claim 4.

12. The powder core according to claim 8, wherein the density of the powder core is 95% or more of the true density.

13. The powder core according to claim 9, wherein the density of the powder core is 95% or more of the true density.

14. The powder core according to claim 10, wherein the density of the powder core is 95% or more of the true density.

15. The powder core according to claim 11, wherein the density of the powder core is 95% or more of the true density.

16. A manufacturing method for a ferromagnetic-metal-based powder comprising the step of forming an insulate coating containing silicone resin and pigment on the surface of a ferromagnetic raw metal powder.

17. The manufacturing method for a ferromagnetic-metal-based powder according to claim 16, comprising the step of spraying paint containing silicone resin and pigment on the raw material powder in a fluidized state so as to form an insulate coating on the surface of the raw material powder.

18. The manufacturing method for a ferromagnetic-metal-based powder according to claim 16, comprising the steps of:
adding paint containing silicone resin and pigment to the raw material powder;
agitating and mixing the resulting mixture; and
performing a drying treatment so as to form an insulate coating on the surface of the raw material powder.

19. The manufacturing method for a ferromagnetic-metal-based powder according to claim 16, wherein the raw material powder is a powder primarily comprising iron, and an iron-based powder is formed.

20. The manufacturing method for a ferromagnetic-metal-based powder according to claim 17, wherein the raw material powder is a powder primarily comprising iron, and an iron-based powder is formed.

21. The manufacturing method for a ferromagnetic-metal-based powder according to claim 18, wherein the raw material powder is a powder primarily comprising iron, and an iron-based powder is formed.

22. The manufacturing method for a ferromagnetic-metal-based powder according to any one of claims 16 to 21, wherein a coating containing at least one material selected from the group consisting of silicon compounds, titanium compounds, zirconium compounds, phosphorus compounds, and chromium compounds is formed beforehand on the surface of the raw material powder.

23. The manufacturing method for a ferromagnetic-metal-based powder including an insulate coating according to any one of claims 16 to 21, wherein the ratio of the silicone resin content to the pigment content in the paint is 0.01 or more, but less than 4.0 on a mass basis.
